(19) United States
(12) Patent Application Publication
(10) Pub. No.: US 2026/0018846 A1
(43) Pub. Date: Jan. 15, 2026

(54) REDUCING ENERGY CONSUMPTION OF A GAS DISCHARGE CHAMBER BLOWER

(71) Applicant: Cymer, LLC, San Diego, CA (US)

(72) Inventors: Ge Song, San Diego, CA (US); Spencer Ryan Williams, San Diego, CA (US)

(21) Appl. No.: 18/875,979

(22) PCT Filed: Sep. 26, 2023
(86) PCT No.: PCT/US2023/075097

§ 371 Date: Dec. 17, 2024

Related U.S. Application Data
(60) Provisional application No. 63/411,452, filed on Sep. 29, 2022.

(51) Int. Cl. H01S 3/00; H01S 3/036; H01S 3/23

(52) U.S. Cl. CPC H01S 3/0014; H01S 3/036; H01S 3/2308

(57) ABSTRACT

A control apparatus for a light source including a plurality of gas discharge chambers with a blower being arranged in each gas discharge chamber. The control apparatus includes: a fault monitoring module configured to, at regular intervals of usage of the light source, monitor one or more operating conditions of the light source, and, for each monitored operating condition, determine a fault status and a fault type that relates to which blower of a gas discharge chamber influences the monitored operating condition; and a control module configured to receive the determined fault statuses and the determined fault types from the fault monitoring module; select at least one gas discharge chamber; and send an instruction to the blower in the selected at least one gas discharge chamber, the instruction being based on the determined fault statuses and the determined fault types.

### CROSS-REFERENCE TO RELATED APPLICATIONS

This application claims priority of U.S. application 63/411,452 which was filed on 29 Sep. 2022 and which is incorporated herein in its entirety by reference.

### TECHNICAL FIELD

The disclosed subject matter relates to controlling a blower arranged in a gas discharge chamber of a light source to thereby reduce energy consumed by the blower during operation of the light source.

### BACKGROUND

One kind of gas discharge light source used in photolithography is termed an excimer light source or laser. Typically, an excimer laser uses a combination of one or more noble gases, which can include argon, krypton, or xenon, and a reactive gas, which can include fluorine or chlorine. The excimer laser can create an excimer, a pseudo-molecule, under appropriate conditions of electrical simulation (energy supplied) and high pressure (of the gas mixture), the excimer only existing in an energized state. The excimer in an energized state gives rise to amplified light in the ultraviolet range. An excimer light source can use a single gas discharge chamber or a plurality of gas discharge chambers. When the excimer light source is performing, the excimer light source produces a deep ultraviolet (DUV) light beam. DUV light can include wavelengths from, for example, about 100 nanometers (nm) to about 400 nm.

The DUV light beam can be directed to a photolithography exposure apparatus or scanner, which is a machine that applies a desired pattern onto a target portion of a substrate (such as a silicon wafer). The DUV light beam interacts with a projection optical system, which projects the DUV light beam through a mask onto the photoresist of the wafer. In this way, one or more layers of chip design is patterned onto the photoresist and the wafer is subsequently etched and cleaned.

### SUMMARY

In some general aspects, a control apparatus is configured for a light source. The light source includes a plurality of gas discharge chambers with a blower being arranged in each gas discharge chamber. The control apparatus includes: a fault monitoring module configured to monitor one or more operating conditions of the light source, and, for each monitored operating condition, determine a fault status and a fault type that relates to which blower of a gas discharge chamber influences the monitored operating condition: and a control module configured to receive the determined fault statuses and the determined fault types from the fault monitoring module; select at least one gas discharge chamber; and send an instruction to the blower in the selected at least one gas discharge chamber, the instruction being based on the determined fault statuses and the determined fault types.

Implementations can include one or more of the following features. For example, the fault monitoring module can be configured to, for each monitored operating condition, determine a priority relating to the monitored operating condition; and the control module can be configured to select the at least one gas discharge chamber based on the determined priority. The fault monitoring module can be configured to monitor the one or more operating conditions of the light source at regular intervals of usage of the light source, and the control module can be configured to select at least one gas discharge chamber based on the gas discharge chamber that was selected by the control module during the most recent prior interval of usage. The plurality of gas discharge chambers can include a master oscillator gas discharge chamber and a power amplifier gas discharge chamber optically in series with the master oscillator gas discharge chamber, and the fault type can be selected from a set of possible fault types that includes a power amplifier fault type, a master oscillator fault type, and a common fault type.

Each of the one or more operating conditions can be defined by a performance metric relating to the light source or to a light beam produced by the light source. The one or more performance metrics can include: a wavelength histogram associated with the light beam; an energy dose error associated with the light beam; an energy error associated with the light beam; a bandwidth error associated with the light beam; an operating point of a master oscillator gas discharge chamber; an operating point of a power amplifier gas discharge chamber; a spectral feature accuracy associated with the light beam; and an actuator operating point of the light source.

The fault status determined for the monitored operating condition can be: flagged if a performance metric associated with the monitored operating condition is not within a threshold range of that performance metric; or clear if the performance metric associated with the monitored operating condition is within the threshold range of that performance metric. The fault monitoring module can be configured to determine an overall fault status based on the determined fault statuses of each monitored operating condition, and the control module being configured to select at least one gas discharge chamber and to send the instruction to the blower in the selected at least one gas discharge chamber can include the control module decoding the overall fault status to analyze the determined fault status of each monitored operating condition.

The control module being configured to select at least one gas discharge chamber and to send the instruction to the blower in the selected at least one gas discharge chamber can include the control module being configured to operate in proactive mode if all of the determined fault statuses are clear and to operate in risk mode if any one of the determined fault statuses are flagged. In proactive mode, the control module can be configured to send an instruction to reduce an operating speed of the blower in the selected at least one gas discharge chamber by a decrement speed step size, and, in risk mode, the control module can be configured to send an instruction to increase an operating speed of the blower in the selected at least one gas discharge chamber by an increment speed step size that is larger than the decrement speed step size. The increment speed step size can be less than or equal to 40 rotations per minute (rpm), and the decrement speed step size can be about one half, one third, one fourth, or one fifth of the increment speed step size. In proactive mode, the control module can be configured to: select one of the gas discharge chambers; and send an instruction to reduce an operating speed of the blower arranged in the selected gas discharge chamber to a decreased operating speed if the decreased operating speed is above a baseline speed. The control module can be configured to send an instruction to increase the operating speed of the blower arranged in the selected gas discharge chamber if a current operating speed of the blower arranged in the selected gas discharge chamber is below the baseline speed and to send an instruction to maintain the operating speed of the blower arranged in the selected gas discharge chamber if the current operating speed of the blower arranged in the selected gas discharge chamber is at the baseline speed. The control apparatus can further include a baseline module configured to control the baseline speed of each blower of each gas discharge chamber, the control of a particular blower baseline speed being related to an age of the gas discharge chamber in which the blower is housed. The fault monitoring module can be configured to determine a fault priority for each monitored operating condition. In risk mode, the control module can be configured to: analyze the fault status of each monitored operating condition to determine which one or more fault statuses are flagged: if a plurality of fault statuses are flagged, then select one of the flagged fault statuses based on the determined fault priority, and, if a single fault status is flagged, then select that single flagged fault status; select a gas discharge chamber based on the fault type associated with the selected fault status; and send an instruction to increase the operating speed of the blower of the selected gas discharge chamber. The fault type can be associated with a single gas discharge chamber or can be associated with a plurality of gas discharge chambers. In risk mode, the control module being configured to select the gas discharge chamber based on the fault type associated with the selected fault status can include either selecting the single gas discharge chamber associated with the fault type or selecting a gas discharge chamber from the plurality of gas discharge chambers associated with the fault type. In risk mode, after the operating speed of the blower of the selected gas discharge chamber has been increased, the control module can be configured to: enter a holding state; after the holding state ends: receive, for each monitored operating condition, the next determined fault status and fault type from the fault monitoring module; analyze the fault status of each monitored operating condition to determine which one or more fault statuses are flagged; if any of the one or more fault statuses are flagged, then: if a plurality of fault statuses are flagged, then select one of the flagged fault statuses based on the determined fault priority, and, if a single fault status is flagged, then select that single flagged fault status; select a gas discharge chamber based on the fault type associated with the selected fault status; and send an instruction to increase the operating speed of the blower of the selected gas discharge chamber; and, if none of the one or more fault statuses are flagged, then exit risk mode and wait for the next determined fault status and fault type from the fault monitoring module.

The fault monitoring module can be configured to monitor the one or more operating conditions of the light source at regular intervals of usage of the light source, and the regular intervals of usage of the light source can be measured as a number of pulses of a light beam produced by the light source. The regular intervals of usage can include first regular intervals of usage and second regular intervals of usage that are greater than the first regular intervals of usage. The fault monitoring module can be configured to operate using the second regular intervals of usage after both determining a flagged fault status using the first regular interval of usage and subsequently determining zero flagged fault statuses in a next interval of usage.

In other general aspects, a method is configured for controlling a plurality of blowers, each blower arranged in a gas discharge chamber of a light source. The method includes: at regular intervals of usage of the light source, monitoring one or more operating conditions of the light source; for each monitored operating condition, determining a fault status and a fault type that relates to which blower of a gas discharge chamber influences the monitored operating condition; selecting at least one gas discharge chamber; and sending an instruction to the blower in the selected at least one gas discharge chamber, the instruction being based on the determined fault statuses and the determined fault types.

Implementations can include one or more of the following features. For example, the method can further include, for each monitored operating condition, determining a priority relating to the monitored operating condition. The at least one gas discharge chamber can be selected by selecting the at least one gas discharge chamber based on the determined priority. The at least one gas discharge chamber can be selected by selecting the at least one gas discharge chamber based on the gas discharge chamber that was selected during the most recent prior interval of usage. The fault status determined for the monitored operating condition can be: flagged if a performance metric associated with the monitored operating condition is not within a threshold range of the performance metric; or clear if the performance metric associated with the monitored operating condition is within the threshold range of the performance metric. The method can also include determining an overall fault status based on the determined fault statuses of each monitored operating condition. The at least one gas discharge chamber can be selected and the instruction can be sent to the blower in the selected at least one gas discharge chamber by decoding the overall fault status to analyze the determined fault status of each monitored operating condition.

The at least one gas discharge chamber can be selected and the instruction can be sent to the blower in the selected at least one gas discharge chamber by operating in proactive mode if all of the determined fault statuses are clear and operating in risk mode if any one of the determined fault statuses are flagged. In the proactive mode, the instruction can be sent to the blower by sending an instruction to reduce an operating speed of the blower in the selected at least one gas discharge chamber by a decrement speed step size and, in the risk mode, the instruction can be sent to the blower by sending an instruction to increase an operating speed of the blower in the selected at least one gas discharge chamber by an increment speed step size that is larger than the decrement speed step size. In the proactive mode: the at least one gas discharge chamber can be selected by selecting one of the gas discharge chambers; and the instruction to the blower can be sent by sending an instruction to reduce an operating speed of the blower arranged in the selected gas discharge chamber to a decreased operating speed if the decreased operating speed is above a baseline speed. The instruction can be sent to the blower by sending an instruction to increase the operating speed of the blower arranged in the selected gas discharge chamber if a current operating speed of the blower arranged in the selected gas discharge chamber is at or below the baseline speed. The instruction can be sent to the blower by sending an instruction to maintain the operating speed of the blower arranged in the selected gas discharge chamber if the current operating speed of the blower arranged in the selected gas discharge chamber is within a threshold value of the baseline speed. The method can further include controlling the baseline speed of each blower of each gas discharge chamber, the control of a particular blower baseline speed being related to an age of the gas discharge chamber in which the blower is housed. The method can also include determining a fault priority for each monitored operating condition. And, operating in the risk mode can include: analyzing the fault status of each monitored operating condition to determine which one or more fault statuses are flagged; if a plurality of fault statuses are flagged, then selecting one of the flagged fault statuses based on the determined fault priority, and, if a single fault status is flagged, then selecting that single flagged fault status; selecting a gas discharge chamber based on the fault type associated with the selected fault status; and sending an instruction to increase the operating speed of the blower of the selected gas discharge chamber. The fault type can be associated with a single gas discharge chamber or can be associated with a plurality of gas discharge chambers; and operating in the risk mode can include selecting the gas discharge chamber based on the fault type associated with the selected fault status including either selecting the single gas discharge chamber associated with the fault type or selecting a gas discharge chamber from the plurality of gas discharge chambers associated with the fault type.

Operating in the risk mode can include, after the operating speed of the blower of the selected gas discharge chamber has been increased: entering a holding state; after the holding state ends: analyzing the next determined fault status of each monitored operating condition to determine which one or more fault statuses are flagged; if any of the one or more fault statuses are flagged, then: if a plurality of fault statuses are flagged, then selecting one of the flagged fault statuses based on the determined fault priority, and, if a single fault status is flagged, then selecting that single flagged fault status; selecting a gas discharge chamber based on the fault type associated with the selected fault status; and sending an instruction to increase the operating speed of the blower of the selected gas discharge chamber; and if none of the one or more fault statuses are flagged, then exiting risk mode and waiting for the next determined fault status and fault type.

In other general aspects, a control apparatus is configured for a light source including a first gas discharge chamber and a second gas discharge chamber optically in series with the first gas discharge chamber. The control apparatus includes: a fault monitoring module configured to, at regular intervals, monitor one or more operating conditions of the light source, and for each monitored operating condition, determine a fault status; and a control module configured to send a first instruction to a first blower within the first gas discharge chamber and to send a second instruction to a second blower within the second gas discharge chamber, the first instruction and the second instruction relating to a speed of the first blower and second blower, respectively, and the first instruction and the second instruction being based on the determined fault status.

### DESCRIPTION OF DRAWINGS

FIG. 1 is a block diagram of an ultraviolet light source that produces a light beam for use by a lithography exposure apparatus, the light source including a light generation apparatus having one or more gas discharge chambers, each including a blower, and an apparatus at least partly configured to control a speed of the blower;

FIG. 2 is a block diagram of an implementation of the apparatus of FIG. 1 including a monitoring module, a decrement module, and an increment module, and optionally a baseline module;

FIG. 3 is a schematic illustration showing how an overall fault status of the light source is determined for use by the apparatus of FIGS. 1 and 2 based on one or more operating conditions of the light source;

FIGS. 4A-4C are exemplary graphs showing how a baseline speed changes relative to an age of the discharge chamber for different discharge chambers;

FIG. 5 is a diagram of a state machine representing an implementation of the apparatus, the state machine including a monitoring state (performed by the monitoring module), a decrement state (performed by the decrement module), and an increment state (performed by the increment module);

FIG. 6A is a flow chart of a procedure performed by the decrement module while the state machine is in the decrement state;

FIG. 6B is a flow chart of a procedure performed by the monitoring module while the state machine is in the monitoring state;

FIG. 6C is a flow chart of a procedure performed by the baseline module while the state machine is in a baseline state;

FIG. 6D is a flow chart of a procedure performed by the increment module while the state machine is in the increment state;

FIG. 7A is a flow chart of a procedure performed by the apparatus for controlling the speed of the blower of the light source of FIGS. 1 and 2;

FIG. 7B is an additional step that can be included in the procedure of FIG. 7A;

FIG. 8 is a block diagram of an implementation of a light source in which the light generation apparatus includes two gas discharge chambers in a master oscillator-power amplifier arrangement;

FIG. 9A is a block diagram of an implementation of a light source in which the light generation apparatus includes a plurality of gas discharge chambers and an implementation of the lithography exposure apparatus;

FIG. 9B is a block diagram of an implementation of a projection optical system of the lithography exposure apparatus of FIG. 9A;

FIG. 10 is a block diagram of an implementation of a light source including a plurality of gas discharge chambers and an implementation of the apparatus of FIG. 1 for controlling a speed of each blower in each gas discharge chamber based on a fault status and a fault type:

FIG. 11 is an exemplary table showing a fault type and a fault priority for each performance metric that is monitored;

FIG. 12 is a flow chart of a procedure performed by the apparatus of FIG. 10 for controlling a plurality of blowers, each blower being arranged in a gas discharge chamber of the light source of FIG. 10;

FIG. 13 is a flow chart of a proactive procedure performed in conjunction with the procedure of FIG. 12 by the apparatus of FIG. 10;

FIG. 14 is a flow chart of a risk procedure performed in conjunction with the procedure of FIG. 12 by the apparatus of FIG. 10; and

FIG. 15 is a graph showing the blower speed versus usage of the light source of FIG. 10 and a graph showing a status of the apparatus of FIG. 10 versus the usage of the light source of FIG. 10.

### DESCRIPTION

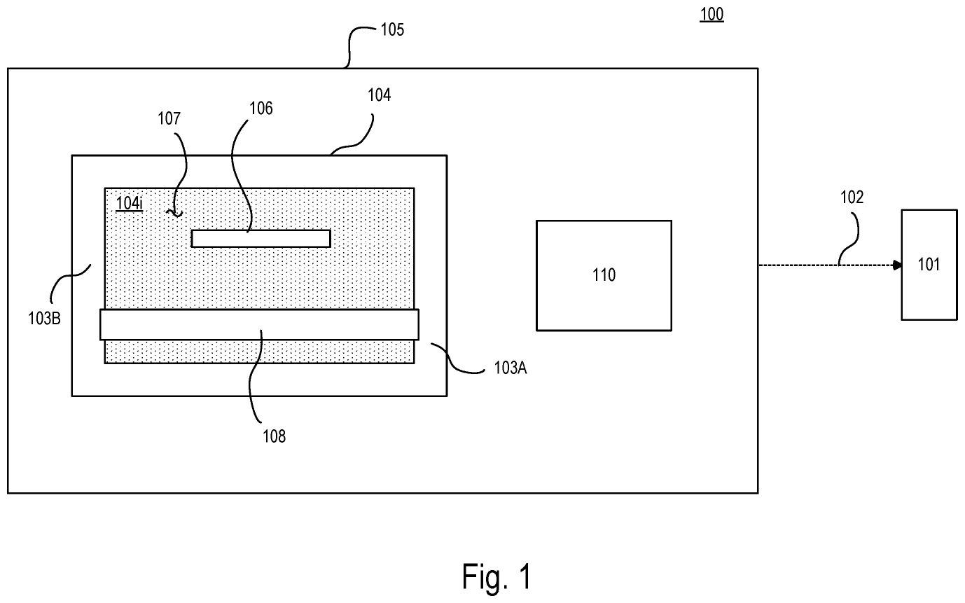

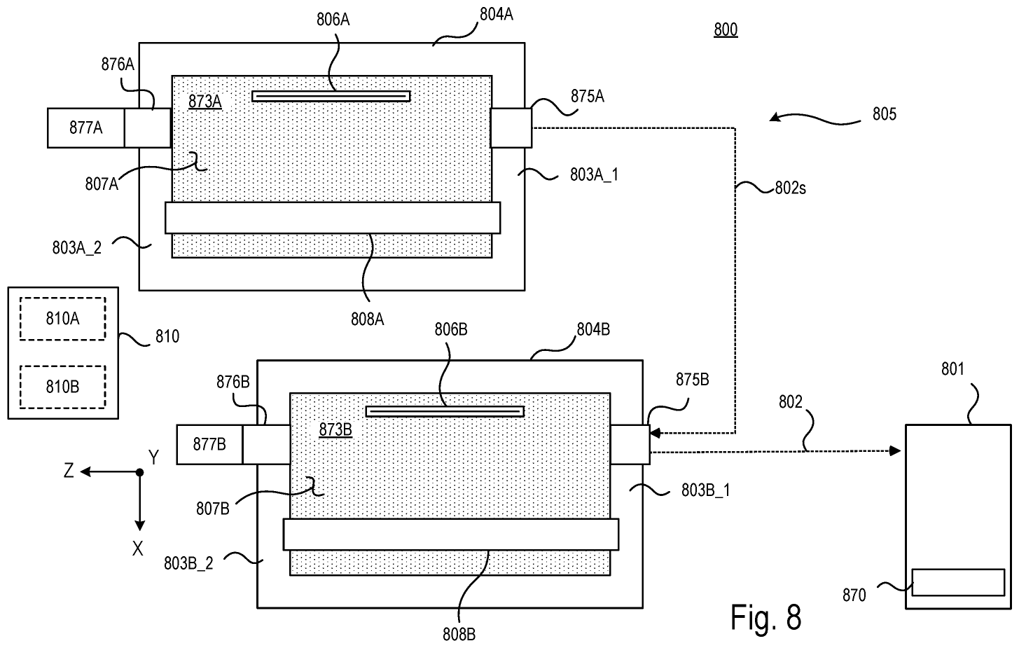

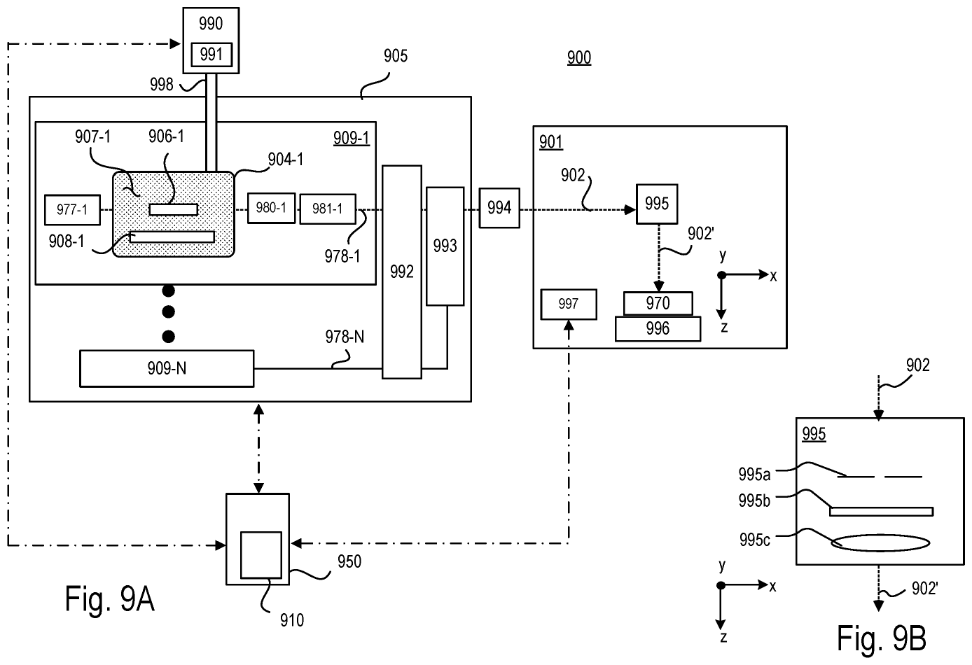

Referring to FIG. 1, an ultraviolet light source 100 includes a light generation apparatus 105 including one or more gas discharge chambers 104, and an apparatus 110. In the example of FIG. 1, the light generation apparatus 105 includes one discharge chamber 104, but it can include a plurality of discharge chambers 104 (such as shown in FIGS. 8 and 9A). The gas discharge chamber 104 is configured to hold a gas mixture 107 including a gain medium within an interior cavity 104i of the gas discharge chamber 104, house an energy source 106 configured to supply energy to the gas mixture 107 to thereby produce a light beam 102. The gain medium of the gas mixture 107 is configured to emit deep ultraviolet (DUV) light in response to a voltage signal being applied to the energy source 106. The energy source 106 can be configured to supply the energy to the gas mixture 107 in short (for example, nanosecond) current pulses using a high-voltage electric discharge interspersed by periods of no energy. The gas mixture 107 produces a pulse of the light beam 102 from a population inversion occurring in the gain medium of the gas mixture 107 by way of stimulated emission when energy from the energy source 106 is provided to the gas mixture 107. As such, the light beam 102 is a pulsed light beam that includes pulses of light that are centered around a wavelength in the DUV range, for example, with wavelengths of 248 nanometers (nm) or 193 nm. For a DUV light source, the gaseous gain medium of the gas mixture 107 can include, for example, argon fluoride (ArF), krypton fluoride (KrF), or xenon chloride (XeCl). The light beam 102 is directed along a path toward a lithography exposure apparatus 101. The light beam 102 is used to pattern microelectronic features on a substrate or wafer received in the lithography exposure apparatus 101. The size of the microelectronic features patterned on the wafer depends on the wavelength of the pulsed light beam 102, with a lower wavelength resulting in a small minimum feature size or critical dimension. For example, when the wavelength of the pulsed light beam 102 is 248 nm or 193 nm, the minimum size of the microelectronic features can be, for example, 50 nm or less.

Specifically, the energy source 106 can include a cathode and an anode, and a potential difference between the cathode and the anode forms an electric field in the gas mixture 107. The electric field provides energy to the gain medium within the gas mixture 107, such energy sufficient to cause a population inversion and to enable generation of a pulse of light via stimulated emission. Repeated creation of such a potential difference forms the train of pulses of light that eventually make up the light beam 102. A “discharge event” is the application of voltage that forms a potential difference sufficient to cause an electrical discharge in the gain medium of the gas mixture 107 and the emission of a pulse of light.

When an optical pulse is generated from the gas mixture 107 near the energy source 106, there is a period of time during which the molecules within the gas mixture 107 recover. This recovery time is longer than the time between pulses of the energy source 106. Moreover, if another pulse of energy is supplied to the recovering gas mixture 107, which remains nearest the energy source 106, then output quality of the resultant optical pulse of the light beam 102 will be reduced and can lead to failure in the light generation apparatus 105. To fix this issue, the gas discharge chamber 104 holds a blower 108, which is fixed to walls 103A, 103B of the gas discharge chamber 104. In various implementations, the blower 108 can include a rotating structure such as a fan. See, for example, U.S. Pat. No. 6,765,946, issued on Jul. 20, 2004 and naming Partlo, et. al. as inventors, which is incorporated herein by reference in its entirety. The blower 108 is configured to regularly displace the portion of the recovering gas mixture 107 away from the energy source 106 within the gas discharge chamber 104 to enable fresh gas mixture 107 to interact with the energy source 106 before a next pulse of the energy source 106 is produced. If the speed of the blower 108 is too low, then arcing, dropouts, and inefficiency can occur in the gas discharge chamber 104, and the gas discharge chamber 104 can fail when the blower 108 is unable to sufficiently clear the portion of the recovering gas mixture 107. Another consideration is that the rotation or motion of the blower 108 can cause vibrations within the gas discharge chamber 104 that can impact one or more spectral properties of the light beam 102 as well as the dose performance of the light beam 102 at the lithography exposure apparatus 101.

During operation of the light source 100, an operating speed of the blower 108 (that is the speed or rate at which the blower 108 rotates about a rotation axis of the blower 108) can be maintained constant at a pre-configured speed. Specifically, the operating speed of the blower 108 can be maintained at a maximum blower speed such that the operating speed 108 of the blower does not change over time and as the light source 100 operates. Under such conditions, the blower 108 can consume a roughly constant amount of energy over time, or, in other words, requires a constant power as the light source 100 operates, which can be expensive and cost inefficient at the least. Accordingly, as discussed herein, the operating speed of the blower 108 is changed or adjusted by the apparatus 110 over time (as the light source 100 operates) based on a fault status of one or more operating conditions of the light source 100 and a baseline speed of the blower 108 (which is the minimum allowed speed of the blower 108). The operating speed of the blower 108 is changed or adjusted by adjusting an operating speed setpoint of the blower 108. In this way, the apparatus 110 acts as a blower controller that controls the operating speed of the blower 108 by adjusting the operating speed between a minimum blower speed and a maximum blower speed that together define a safe blower speed range of the blower 108 during operation of the light source 100. In other words, as the light source 100 operates, the apparatus 110 adjusts the operating speed of the blower 108 within a safe blower speed range within which failures and/or problems do not occur within the light source 100, and also adjusts the operating speed of the blower 108 such that more energy is conserved by the blower 108 and, thus, less energy is consumed by the light source 100. Details of the apparatus 110 are provided next.

The apparatus 110 performs the analysis and sends an instruction regarding the operating speed of the blower 108 at regular intervals of usage of operation of the light source 100. An interval of usage can be based on the number of pulses of the light beam 102 produced by the light generation apparatus 105. Thus, for example, the apparatus 110 can perform the analysis and send the instruction every 5 million pulses of the light beam 102. At certain times, depending on the current status of the performance of the light source 100, the interval of usage can be increased to, for example, 10 million pulses of the light beam 102.

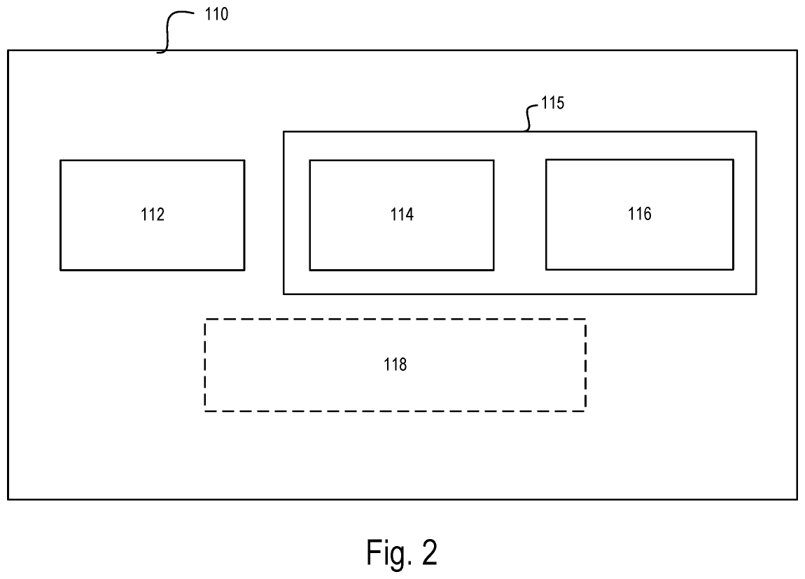

Referring to FIG. 2, the apparatus 110 (or blower controller) includes a monitoring module 112 and a control module 115 that includes a decrement module 114 and an increment module 116.

In general, the monitoring module 112 is configured to monitor a fault status relating to one or more operating conditions of the light source 100. For example, each of the one or more operating conditions can be defined by a performance metric relating to the light source 100 or to the light beam 102 produced by the light source 100. The fault status can be considered to be flagged if at least one of the associated performance metrics is not within a threshold range of that performance metric, and the fault status can be considered to be clear if all of the associated performance metrics are within their respective threshold range. Thus, as the light source 100 operates, the monitoring module 112 can monitor the one or more operating conditions of the light source 100 by monitoring the one or more associated performance metrics.

In general, the decrement module 114 is configured to decrease the operating speed of the blower 108 if the fault status relating to one or more operating conditions of the light source 100 is clear and if the decreased operating speed would be at or above the baseline speed of the blower 108 (which is the minimum allowed speed of the blower 108). For example, the decrement module 114 can be configured to reduce the operating speed of the blower 108 by a decrement speed step size.

In general, the increment module 116 is configured to increase the operating speed of the blower 108 if the fault status of one or more operating conditions of the light source 100 is flagged. The increment module 116 can be configured to increase the operating speed of the blower 108 by an increment speed step size. In one example, the increment step size can be, for example, less than or equal to 25 rotations per minute (rpm). In this example, the increment speed step size is larger than the decrement speed step size, which can be about one half, one third, one fourth, or one fifth of the increment speed step size. In some implementations, the increment step size can be less than or equal to 40 rpm.

The apparatus 110 can also include a baseline module 118 configured to increase the operating speed of the blower 108 if the operating speed of the blower 108 is below the baseline speed.

As the light source 100 operates, the operating speed of the blower 108 is adjusted by the increment and decrement modules 114, 116, and also the baseline module 118, within a blower speed range defined by a minimum blower speed and a maximum blower speed. The blower speed range is a safe range within which the light source 100 does not have problems and/or failures, and properly operates. In this way, the apparatus 110 controls the operating speed of the blower 108 by adjusting the operating speed within the safe blower speed range such that minimal energy is consumed by the blower 108 and the energy consumed by the light source 100 is reduced.

The modules 112, 114, 116, 118 of the apparatus 110 can be implemented in a control system in communication with the blower 108 to thereby control the blower 108. As such, the control system of the blower controller 108 is configured to monitor the fault status of one or more operating conditions of the light source 100, decrease the operating speed of the blower 108 in a decrement state if the fault status relating to one or more operating conditions of the light source 100 is clear and if the decreased operating speed would be at or above a baseline speed, and increase the operating speed of the blower 108 in an increment state if the fault status relating to one or more operating conditions of the light source 100 is flagged. The control system of the blower controller 110 can also be configured to increase the operating speed of the blower 108 in the increment state if the decreased operating speed of the blower 108 is below the baseline speed.

The apparatus 110 can include, for example, a computer-readable memory module, and one or more electronic processors coupled to the computer-readable memory module. Each of the modules 112, 114, 116, 118 can be in communication with the memory module and can be controlled by the one or more electronic processors. For example, each module 112, 114, 116, 118 can include or have access to one or more programmable processors and can each execute a program of instructions to perform desired functions by operating on input data and generating appropriate output. Each module 112, 114, 116, 118 can be implemented in any of digital electronic circuitry, computer hardware, firmware, or software. In further implementations, each module 112, 114, 116, 118 accesses memory within the memory module, which is also configured to store information output from one or more of the module 112, 114, 116, 118, information from the discharge chamber 104, or information about other aspects of the light generation apparatus 105, such information being available for various use by the modules 112, 114, 116, 118 during operation of the apparatus 110. The memory within the memory module can be read-only memory and/or random-access memory and can provide a storage device suitable for tangibly embodying computer program instructions and data. The apparatus 110 can also include one or more input devices (such as a keyboard, touch-enabled devices, audio input devices) and one or more output devices such as audio output or video output.

In examples in which the apparatus 110 acts as a blower controller, the fault status relating to the one or more operating conditions can be defined (by the control system) using binary notation. Specifically, the fault status can be assigned a value of zero (0) if the fault status is clear and a value of one (1) if the fault status is flagged. Details of the fault status relating to one or more operating conditions of the light source 100 are provided next.

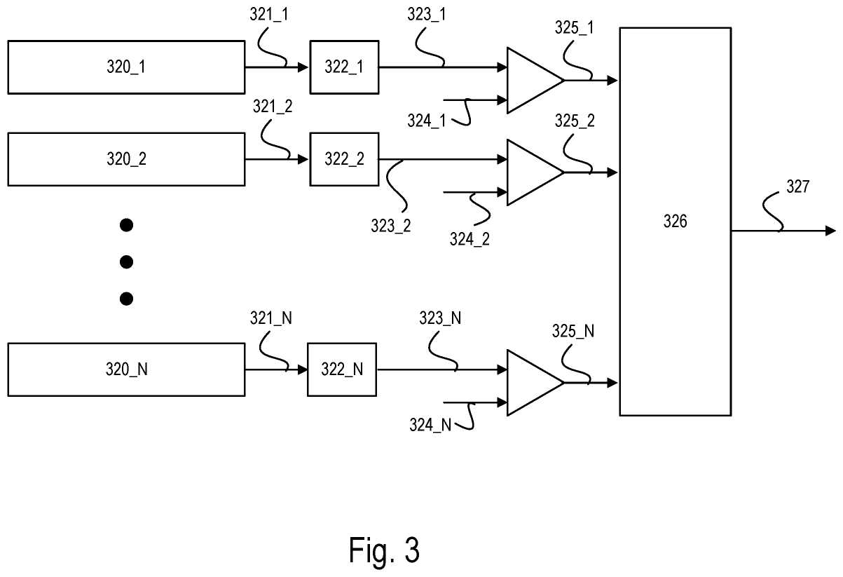

Referring to FIG. 3, an overall fault status 327 of the light source 100 is determined by the apparatus 110 at each iteration based on one or more operating conditions of the light source 100. Each of the one or more operating conditions is defined by a performance metric 320_1 to 320_N relating to the light source 100 or to the light beam 102 produced by the light source 100. The fault status 327 that the apparatus 110 uses to control the blower 108 should be based on system parameters, metrics, and signals that are affected in a significant manner by changes in the speed of the blower 108.

In the example of FIG. 3, the one or more performance metrics 320_1 to 320_N include a spectral feature accuracy associated with the light beam 102, an energy dose error associated with the light beam 102, an energy error associated with the light beam 102, an actuator operating point of the light generation apparatus 105 within the light source 100, and a gas discharge chamber dropout rate.

The spectral feature accuracy represents the stability and accuracy of a spectral feature (such as the wavelength) of the light beam 102 produced by the light source 100. Specifically, the spectral feature accuracy relating to wavelength is based on a mean and a standard deviation of the error of the wavelength of the light beam 102 calculated over a moving window of M pulses of the light beam 102, for M is an integer number equal to or greater than one. The value of the spectral feature accuracy can be measured/calculated directly, or it can be estimated from other measured data.

The energy dose error represents a difference between a desired or target dose at the wafer and an actual dose at the wafer received in the lithography exposure apparatus 107. The dose at the wafer is the amount of optical energy that the light beam 102 delivers per unit area over an exposure time or a particular number of pulses at the wafer. While the energy dose error could be directly measured/calculated, it is alternatively possible to estimate the energy dose error from other measured data.

The energy error represents a standard deviation of the measured energy of the light beam 102. In particular, the energy error can be considered a difference between the amount of energy in the pulse of the light beam 102 and a target energy. While the energy error could be directly measured, it is alternatively possible to estimate the energy error from other data.

The actuator operating point of the light generation apparatus 105 characterizes where, within a range of possible settings, values, or conditions, an actuator within the light generation apparatus 105 is operating. In some implementations, as discussed below with respect to FIG. 8, the actuator can be a timing module that is connected to a first stage including a first discharge chamber 804A (the first stage constituting a master oscillator) and a second stage including a second discharge chamber 804B (the second stage constituting a power amplifier) of a light generation apparatus 805. Such a timing module controls a relative timing between a first trigger signal sent to a first energy source 806A of the first discharge chamber 804A and a second trigger signal sent to the second energy source 806B of the second discharge chamber 804B. This relative timing can be referred to as differential timing. In these implementations, the metric for the actuator operating point of the light generation apparatus 805 can quantify a displacement of the actual relative timing from a peak efficiency differential timing (Tpeak), where Tpeak is the value of the relative timing when the light generation apparatus 805 produces a light beam 802 having a maximum energy at a particular input energy applied to the light generation apparatus 805 (via the energy sources 806A, 806B). This metric for the actuator operating point can be calculated or estimated based on a voltage or energy supplied to the energy sources 806A, 806B; an output energy of the light beam 802, and the differential timing.

The gas discharge chamber dropout rate quantifies the failure mechanism in which the blower 108 is unable to sufficiently clear the portion of the recovering gas mixture 107 and thus, the gas mixture is not moved fast enough through the gas discharge chamber 104, which causes arcing and energy loss in the gas discharge chamber 104.

In some implementations, as discussed above, one or more of the performance metrics 320_1 to 320_N relating to the light source 100 can be unavailable at certain moments during operation or within certain systems, and the apparatus 110 can estimate a value of the unavailable performance metrics to determine the fault status 327 based on other available data. To calculate the overall fault status 327, the apparatus 110 receives the performance metrics 320_1, 320_2, . . . 320_N.

Each of the one or more performance metrics 320_1 to 320_N is associated with a respective value 321_1 to 321_N that is passed through a respective filter 322_1 to 322_N to remove the effect of noise or temporary performance issues that can occur during operation. For example, each of the filters 322_1 to 322_N can be a low pass filter or a weighted sum filter, such that the fault status 327 relating to the one or more operating conditions 320_1 to 320_N of the light source 100 is determined using the filter 322_1 to 322_N (including the low pass filter or the weighted sum filter). Moreover, each of the filters 322_1 to 322_N can have a configurable transfer function to filter the values 321_1 to 321_N of the performance metrics 320_1 to 320_N.

Filtered values 323_1 to 323_N of the performance metrics 320_1 to 320_N are output from each of the respective filters 322_1 to 322_N. To determine a respective fault status 325_1 to 325_N that is associated with each of the performance metrics 320_1 to 320_N (and, thus, operating conditions), each of the filtered values 323_1 to 323_N are compared to a respective threshold range 324_1 to 324_N that is associated with that respective performance metric 320_1 to 320_N. If it is determined that the respective performance metric 320_1 to 320_N is not within the threshold range 324_1 to 324_N of that performance metric 320_1 to 320_N, then the fault status 325_1 to 325_N of that performance metric 320_1 to 320_N is flagged. If it is determined that the respective performance metric 320_1 to 320_N is within the threshold range 324_1 to 324_N of that performance metric 320_1 to 320_N, then the fault status 325_1 to 325_N of that performance metric 320_1 to 320_N is clear. As described above, the fault status 325_1 to 325_N can be assigned a value of zero (0) if the fault status 325_1 to 325_N is clear and a value of one (1) if the fault status 325_1 to 325_N is flagged.

Each fault status 325_1 to 325_N is input to a fault status module 326 (which can be a controller) that determines the overall fault status 327 of the light source 100 based on the fault statuses 325_1 to 325_N of the performance metrics 320_1 to 320_N that relate to the light source 100. For example, in some implementations, if any one of the fault statuses 325_1 to 325_N is flagged (or has a value of 1), then the overall fault status 327 of the light source 100 is flagged (or has a value of 1). And, if all of the fault statuses 325_1 to 325_N are clear (or have a value of 0), then the overall fault status 327 of the light source 100 is clear (or has a value of 0). In this way, the overall fault status 327 of the light source 100 can be determined, and the apparatus 110 can control the blower 108 based on the fault status 327 of the light source 100 to thereby reduce energy consumption by the blower 108 during operation. In other implementations, the fault status module 326 can be configured to flag the overall fault status 325 only if a plurality of the fault statuses 325_1 to 325_N are flagged.

Details of the baseline speed of the blower 108 are provided next.

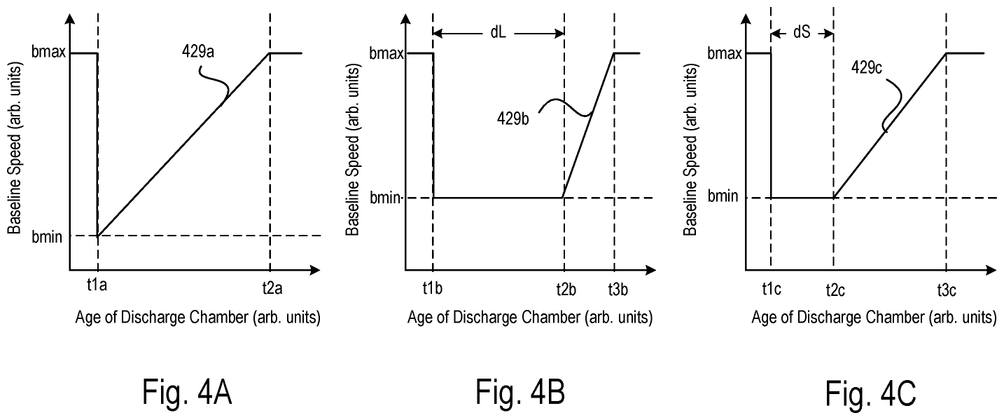

Referring to FIGS. 4A-4C, the baseline speed of the blower 108 can be related to an age of the gas discharge chamber 104. In the examples of FIGS. 4A-4C, the baseline speed changes as the gas discharge chamber 104 ages over time. In other words, the baseline speed changes as the number of pulses of the light beam 102 generated by the gas discharge chamber 104 increases over time (and as the gas discharge chamber 104 ages). In these examples, the apparatus 110 adjusts the baseline speed of the blower 108 between a minimum baseline speed bmin and a maximum baseline speed bmax. Any of the modules 114, 116, 118 or another module of the apparatus 110 can perform this adjustment. In general, the baseline speed of the blower 108 is required to be increased as the gas discharge chamber 104 ages and performance failures, problems, and/or errors occur more frequently within the aging light source 100 (and within the gas discharge chamber 104). By increasing the baseline speed of the gas discharge chamber 104 as the discharge chamber 104 ages, the performance failures, problems, and/or errors that can occur within the aging light source 100 are reduced or mitigated.

In the example of FIG. 4A, the apparatus 110 adjusts the baseline speed from the maximum baseline speed bmax to the minimum baseline speed bmin at time t1a. Then, at time t1a, the apparatus 110 begins to gradually increase the baseline speed. The baseline speed of the blower 108 is incremented at a constant rate 429a (or slope) as the gas discharge chamber 104 ages over time (or as pulses of the light beam 102 are generated by the gas discharge chamber 104). The baseline speed of the blower 108 is increased or incremented from the minimum baseline speed bmin to the maximum baseline speed bmax such that the baseline speed reaches the maximum baseline speed bmax at time t2a that is at the end of the lifetime of the gas discharge chamber 104.

In the example of FIG. 4B, the apparatus 110 adjusts the baseline speed from the maximum baseline speed bmax to the minimum baseline speed bmin at time t1b. While the gas discharge chamber 104 remains young in age for an amount of time dL between times t1b and t2b, the baseline speed of the blower 108 is not changed and remains constant at the minimum baseline speed bmin. Because the gas discharge chamber 104 is young in age between times t1b and t2b, in this example, there is no requirement to increase the baseline speed in order to reduce or mitigate performance problems within the light source 100.

At time t2b, the apparatus 110 begins to increase or increment the baseline speed. The baseline speed of the blower 108 is incremented at a constant rate 429b (or slope) as the gas discharge chamber 104 becomes older and ages over time (and as pulses of the light beam 102 are generated by the gas discharge chamber 104). The baseline speed of the blower 108 is increased or incremented from the minimum baseline speed bmin to the maximum baseline speed bmax such that the baseline speed reaches the maximum baseline speed bmax at time t3b that is at the end of the lifetime of the gas discharge chamber 104.

The example of FIG. 4C is similar to the example of FIG. 4B, except the baseline speed of the blower 108 remains constant for a shorter amount of time dS and the baseline speed is incremented at a rate 429c that is slower than the rate 429b. After decrementing the baseline speed to the minimum baseline speed bmin at time t1e, and maintaining this minimum baseline speed bmin for a time dS, at time t2c, the baseline speed is increased at the constant rate 429c as the gas discharge chamber 104 becomes older and ages over time until the baseline speed of the blower 108 reaches the maximum baseline speed bmax at time t3c, which is at the end of the lifetime of the gas discharge chamber 104.

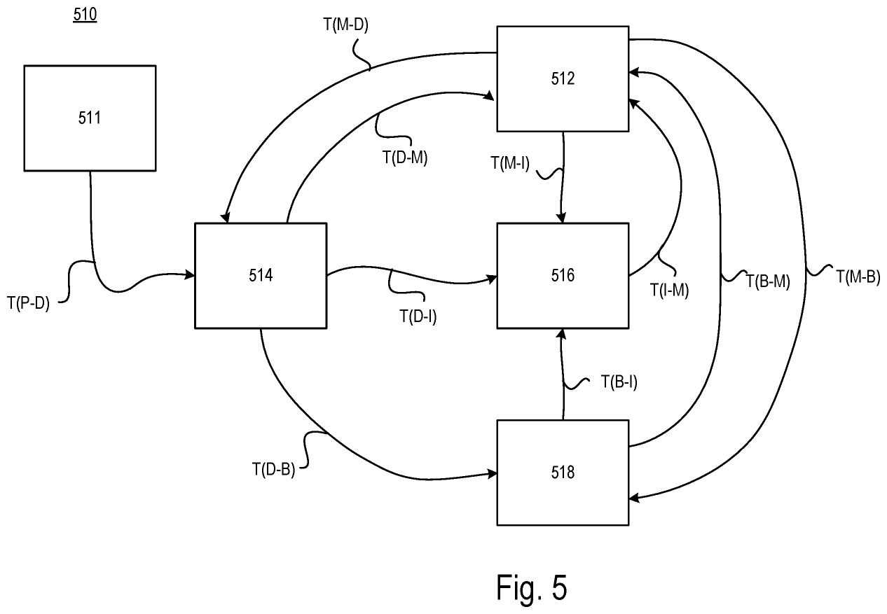

Referring to FIG. 5, the apparatus 110 (FIG. 2) is represented as a state machine 510 for the light source 100. In this representation of the state machine 510, the monitoring module 112 is represented by a monitoring state 512, the decrement module 114 is represented by a decrement state 514, and the increment module 116 is represented by an increment state 516. The state machine 510 can also include a baseline state 518, which represents the baseline module 118 (FIG. 2). Moreover, in this implementation, the state machine 510 includes a passive state 511 in which there are no commands or instructions from the state machine 510 to change or adjust the operating speed of the blower 108.

The state machine 510 transitions from the passive state 511 to the decrement state 514 T(P-D) if a number of pulses of the light beam 102 generated from the gas discharge chamber 104 is above a threshold value or after the state machine 510 has been in the passive state 511 for a threshold period of time. In general, the decrement state 514 is configured to reduce the operating speed of the blower 108 if the fault status 327 relating to one or more operating conditions of the light source 100 is clear and if the decreased operating speed would be at or above the baseline speed.

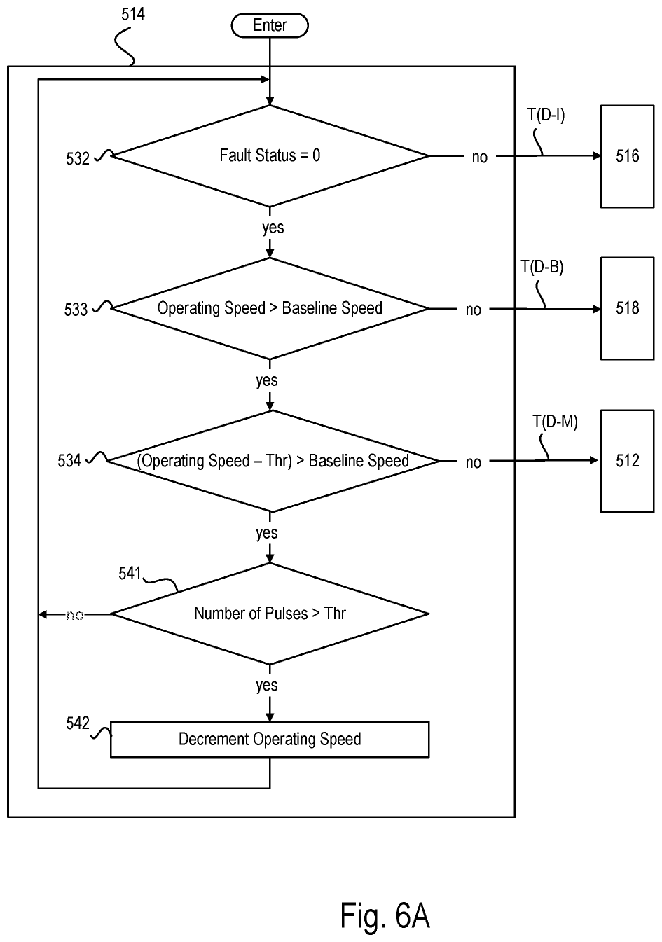

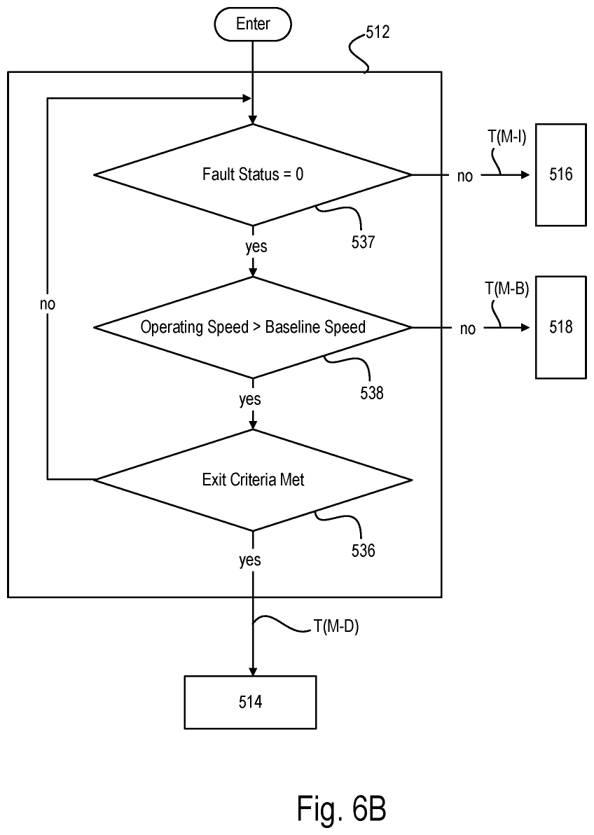

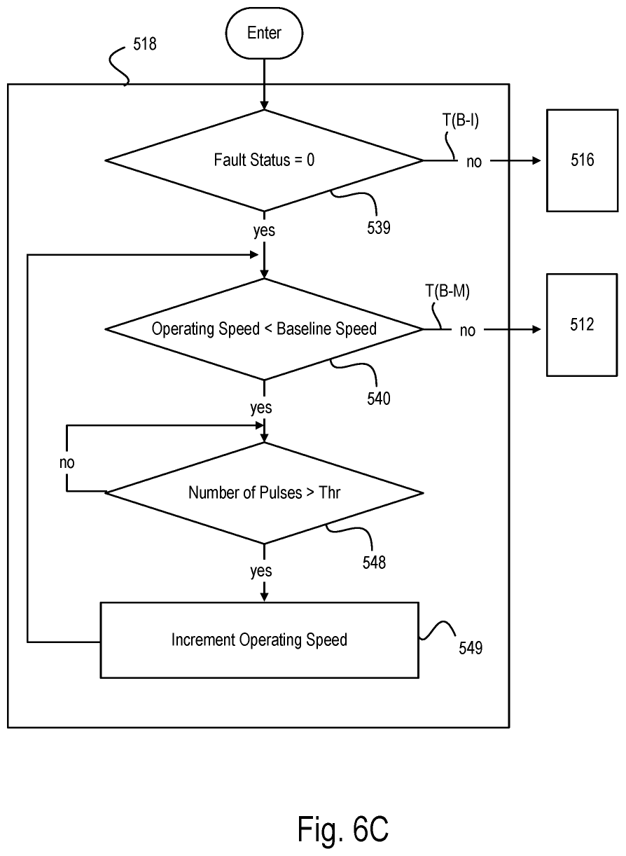

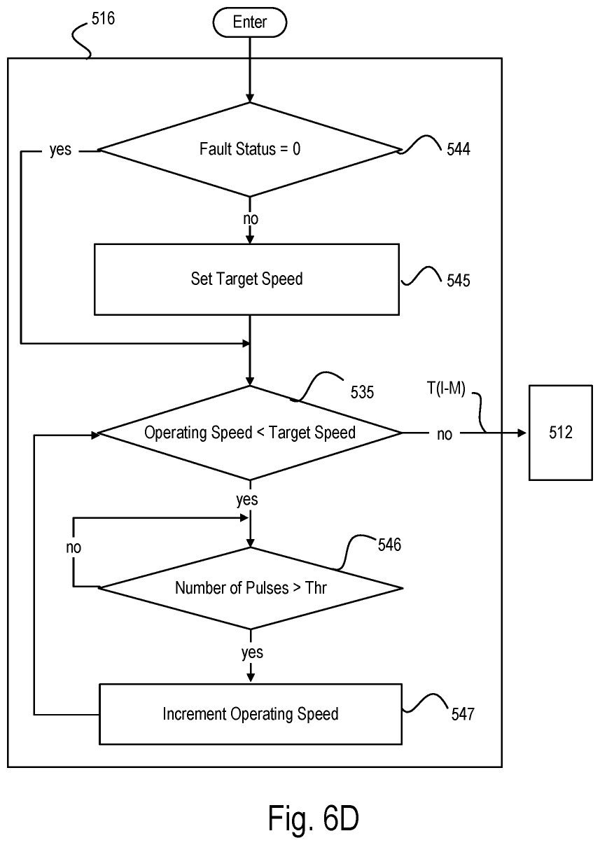

Specifically, and referring also to FIG. 6A, in the decrement state 514, the decrement module 114 determines if the fault status 327 of the light source 100 is clear (for example, at 0) (532). If the fault status 327 is not clear (and thus is flagged or has a value of 1) (532), then the decrement module 114 exits the decrement state 514 and the state machine 510 transitions from the decrement state 514 to the increment state 516 T(D-I) such that the operating speed of the blower 108 is incremented to a safe operating speed at which problems and/or failures do not occur within the light source 100.

If the fault status is clear (or has a value of 0) (532), then the decrement module 114 determines whether the operating speed of the blower 108 is greater than the baseline speed (533). If the operating speed of the blower 108 is not greater than the baseline speed (which means it is either at or less than or crosses below the baseline speed of the blower 108), then the decrement module 114 exits the decrement state 514 and the state machine 510 transitions from the decrement state 514 to the baseline state 518 T(D-B) such that the operating speed of the blower 108 is incremented to a safe operating speed that is above the baseline speed at which problems and/or failures do not occur within the light source 100.

If the operating speed of the blower 108 is greater than the baseline speed (533), then the decrement module 114 determines whether a proposed new blower speed would be greater than the baseline speed (534). The proposed new blower speed is the operating speed of the blower 108 minus a decrement speed step size. If the proposed new speed of the blower 108 would not be greater than the baseline speed (that is, the proposed new blower speed would be either at the baseline speed or less than the baseline speed) (534), then the decrement module 114 exits the decrement state 514 and the state machine 510 transitions from the decrement state 514 to the monitoring state 512 T(D-M) such that the one or more operating conditions of the light source 100 and the operating speed of the blower 108 can be monitored.

If, on the other hand, the proposed new blower speed would be greater than the baseline speed (534), then the decrement module 114 determines whether the number of pulses of the light beam 102 generated by the gas discharge chamber 104 since the last time the blower speed was changed is greater than a threshold number of pulses (541). The threshold number of pulses can be pre-set to be a positive integer in order to reduce the frequency with which the blower speed is changed. For example, the frequency with which the blower speed is changed can be set to ensure that the light generation apparatus 105 and also the performance metrics have enough time to adjust for the effects of the change in blower speed. Moreover, it is possible to operate in the decrement state 514 without performing this step 541.

If the number of pulses of the light beam 102 generated by the gas discharge chamber 104 is not greater than the threshold number of pulses (and thus, it is equal to or less than a threshold number of pulses) (541). then the decrement module 114 returns to step 532 and repeats steps 532, 533, 534. If the number of pulses of the light beam 102 generated by the gas discharge chamber 104 is greater than the threshold number of pulses (541), then the decrement module 114 instructs the blower 108 to decrease or decrement its operating speed (542). For example, the decrement state 514 can decrement the operating speed of the blower 108 by a decrement speed step size.

After decreasing the operating speed of the blower 108 in the decrement state 514 (542), decrement module 114 returns to querying whether the fault status 327 relating to the one or more operating conditions of the light source 100 is clear (for example, has a value of 0) (532).

Thus, in sum, the decrement module 114 causes the speed of the blower 108 to be reduced (524) if there is no fault (532), if the speed of the blower 108 is greater than the baseline speed (533), if the proposed new blower speed would be greater than the baseline speed (534), and if a certain number of pulses of the light beam 102 have been produced since the last change in the blower speed (541). In this way, the energy consumed by the blower 108 is significantly reduced, especially during the beginning of the lifetime of the light source 100 and the gas discharge chamber 104.

Referring also to FIG. 5, and as discussed above with reference to FIG. 6A, if the proposed new speed of the blower 108 would not be greater than the baseline speed (that is, the proposed new blower speed would be either at the baseline speed or less than the baseline speed) (534), then the decrement module 114 exits the decrement state 514 and the state machine 510 transitions from the decrement state 514 to the monitoring state 512 T(D-M) such that the one or more operating conditions of the light source 100 and the operating speed of the blower 108 can be monitored.

In general, in the monitoring state 512, the monitoring module 112 is configured to monitor exit criteria and remaining in the monitoring state 512 while there is no fault, the blower speed is greater than the baseline speed, and there is no occurrence of an exit criteria event. Referring to FIG. 6B, in the monitoring state 512, the monitoring module 112 determines whether the fault status 327 relating to the one or more operating conditions of the light source 100 is clear (for example, has a value of 0) (537). If the fault status 327 is not clear (and thus is flagged) (537), then the state machine 510 transitions from the monitoring state 512 to the increment state 516 T(M-I) such that the operating speed of the blower 108 is increased to a safe operating speed at which problems and/or failures do not occur within the light source 100.

If the fault status is clear (or has a value of 0) (537), then the monitoring module 112 determines whether the operating speed of the blower 108 is greater than the baseline speed (538). If the operating speed of the blower 108 is less than or below the baseline speed (538), then the state machine 510 transitions from the monitoring state 512 to the baseline state 518 T(M-B) such that the operating speed of the blower 108 is increased to a safe operating speed at which problems and/or failures do not occur within the light source 100. If the operating speed of the blower 108 is greater than the baseline speed (538), then the monitoring module 112 determines whether one or more exit criteria are met (536). For example, the exit criteria can be based on one or more of the baseline speed, a number of pulses of the light beam 102 produced by the light source 100, and events that lead to an improvement in performance of the light source 100. If the exit criteria are met, then the state machine 510 transitions from the monitoring state 512 to the decrement state 514 (because the light source 100 is determined to be in a safe condition to decrease the operating speed of the blower 108) T(M-D). If the exit criteria are not met, then the monitoring module 112 returns to determining whether the fault status 327 relating to the one or more operating conditions of the light source 100 is clear (for example, has a value of 0) (537). One possible exit criterion that can be evaluated at step 536 is a determination as to whether the speed of the blower 108 is greater than the baseline speed plus a lower threshold value (such as 200 rpm). In this case, then it seems more appropriate for the blower speed to be reduced (by way of the decrement state 514). Another possible exit criterion that can be evaluated at step 536 is to determine whether the current produced number of pulses of the light beam 102 is greater than a pre-determined threshold such as 100 million pulses. Alternatively, instead of evaluating a set of exit criteria at step 536 based on a number of produced pulses of the light beam 102, the monitoring module 112 can evaluate whether certain performance-improving events have occurred. For example, a performance-improving event could be a gas refill or injection in which the gas mixture 107 is at least partly or fully replaced. Such an event can lead to an improved performance of the light source 100.

Referring again to FIG. 5, and as discussed above with reference to FIG. 6A, if the operating speed of the blower 108 is at or less than the baseline speed (533), then the decrement module 114 exits the decrement state 514 and the state machine 510 transitions from the decrement state 514 to the baseline state 518 T(D-B) such that the operating speed of the blower 108 is incremented to a safe operating speed that is above the baseline speed at which problems and/or failures do not occur within the light source 100. The baseline state 518 is discussed with reference to FIG. 6C. Generally, the baseline state 518 is configured to increase the operating speed of the blower 108 if the operating speed of the blower 108 is at or below the baseline speed. The baseline module 118 determines if the fault status 327 of the light source 100 is clear (for example, equal to 0) (539). If the fault status 327 is not clear (and is therefore flagged or has a value of 1) (539), then the state machine 510 transitions from the baseline state 518 to the increment state 516 T(B-I) such that the operating speed of the blower 108 is incremented to a safe operating speed at which problems and/or failures do not occur within the light source 100.

If the fault status is clear (or has a value of 0) (539), then the baseline module 118 and determines whether the operating speed of the blower 108 is less than the baseline speed (540). If the operating speed is of the blower 108 is not less than the baseline speed (540), then the state machine 510 transitions from the baseline state 518 to the monitoring state 512 (since the operating speed is not required to be increased) T(B-M). If, on the other hand, the operating speed of the blower 108 is less than the baseline speed (540), then the baseline module 118 determines whether the number of pulses of the light beam 102 generated by the gas discharge chamber 104 since the last time the blower speed was changed is greater than a threshold number of pulses (548). As discussed above, the threshold number of pulses can be pre-set to be a positive integer in order to reduce the frequency with which the blower speed is changed. If the number of pulses of the light beam 102 generated by the gas discharge chamber 104 is not greater than a threshold number of pulses (548), then the baseline module 118 continues to query whether the number of pulses of the light beam 102 generated by the gas discharge chamber 104 since the last time the blower speed was changed in greater than a threshold number of pulses (548).

If the number of pulses of the light beam 102 generated by the gas discharge chamber 104 is greater than the threshold number of pulses (548), then the baseline module 118 increases or increments the operating speed of the blower 108 (549). For example, the baseline module 118 can increment the operating speed of the blower 108 by an increment speed step size. As an example, the increment speed step size can be about 5 rotations per minute (rpm). After increasing the operating speed of the blower 108, the baseline module 118 returns again to step 439 to determine if the fault status 327 of the light source 100 is clear (for example, equal to 0).

Referring again to FIG. 5, and as discussed above with reference to FIGS. 6A-6C, the state machine 510 can transition from any one of the decrement state 514, the monitoring state 512, and the baseline state 518 to the increment state 516. For example, while in the decrement state 514, if the fault status 327 is not clear (and thus is flagged or has a value of 1) (532), then the decrement module 114 exits the decrement state 514 and the state machine 510 transitions from the decrement state 514 to the increment state 516 T(D-I). In general, in the increment state 516, the operating speed of the blower 108 is incremented to a safe operating speed at which problems and/or failures do not occur within the light source 100. The increment state 516 is discussed next with reference to the implementation shown in FIG. 6D.

Specifically, in the increment state 516, the increment module 116 determines if the fault status 327 of the light source 100 is clear (for example, 0) (544). If the fault status 327 is not clear (for example, if the fault status is 1) (544), then the increment module 116 sets a new target speed for the blower 108 (545). The new target speed of the blower 108 can be equal to the operating speed of the blower 108 plus a large increment speed step size (such as, for example, 100 rpm). The idea is to significantly increase the speed of the blower 108 when a fault occurs. After the new target speed for the blower 108 is set (545) or after the increment module 116 determines that the fault status is clear (for example, the fault status is 0) (544), then the increment module 116 determines whether the operating speed of the blower 108 is less than the new target speed (535). If the operating speed of the blower 108 is not less than the new target speed (535), which means that the operating speed of the blower 108 is greater than or equal to the new target speed (535). then the state machine 510 transitions from the increment state 516 to the monitoring state 512 T(I-M).

If the operating speed of the blower 108 is less than the target speed (535), then the increment module 116 determines whether the number of pulses of the light beam 102 generated by the gas discharge chamber 104 is greater than a threshold number of pulses (546). If the number of pulses of the light beam 102 generated by the gas discharge chamber 104 is not greater than a threshold number of pulses, then the increment module 116 continues to query whether the number of pulses of the light beam 102 generated by the gas discharge chamber 104 is greater than a threshold number of pulses (546). If the number of pulses of the light beam 102 generated by the gas discharge chamber 104 is greater than the threshold number of pulses, then the increment module 116 increases or increments the operating speed of the blower 108 by a regular amount (547). For example, the increment module 116 can increment the operating speed of the blower 108 by an increment speed step size such as by 25 rpm. After increasing the operating speed of the blower 108 (547), the increment module 116 returns to step 535 to determine whether the increased operating speed of the blower 108 is less than the target speed (535).

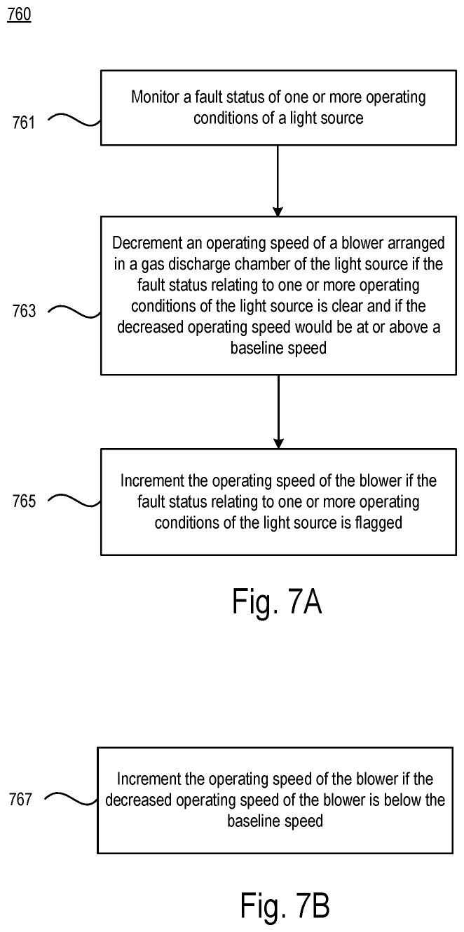

More generally, and while referring to FIG. 7A, the apparatus 110 performs a procedure 760 for controlling the blower 108. The procedure 760 can be performed with respect to the light source 100 (FIG. 1) that includes the apparatus 110 (FIG. 2) and the blower 108 in the gas discharge chamber 104. The procedure 760 can also be performed with respect to the state machine 510 (FIG. 5). In the following, the procedure 760 is described with respect to the light source 100 including the blower 108.

The procedure 760 includes monitoring a fault status of one or more operating conditions of the light source (761). For example, as discussed above with reference to FIG. 6B, the monitoring module 112 monitors the fault status 327 (FIG. 3) of the one or more operating conditions of the light source 100 (537).

Next, the apparatus 110 decrements the operating speed of the blower 108 if the fault status relating to one or more operating conditions of the light source 100 is clear and if the decreased operating speed would be at or above a baseline speed (763). For example, and with reference to FIG. 6A. if the fault status 327 relating to the one or more operating conditions of the light source 100 is clear (532) and if the decreased operating speed of the blower 108 would be above the baseline speed (534), then the decrement module 114 decrements the operating speed of the blower 108 (542). Decrementing the operating speed of the blower 108 can include reducing the operating speed of the blower 108 by a decrement speed step size. Moreover, decrementing the operating speed of the blower 108 can include reducing an amount of vibrations within the light source 100 caused by movement of the blower 108.

On the other hand, and again with reference to FIG. 7A, the apparatus 110 increments the operating speed of the blower 108 if the fault status relating to one or more operating conditions of the light source is flagged (765). For example, with reference to FIG. 6D, if the fault status 327 of the light source 100 is flagged, then the increment module 116 increments the operating speed of the blower 108 (547). Incrementing the operating speed of the blower 108 can include increasing the operating speed of the blower 108 by an increment speed step size. In this way, the increment module 116 prevents the blower 108 from operating at an operating speed that can lead to problems and/or failures within the light source 100.

Referring also to FIG. 7B, the procedure 760 can further include incrementing the operating speed of the blower if the decreased operating speed of the blower is below the baseline speed (767). For example, and with reference to FIG. 6C, if the baseline module 118 determines that the decreased operating speed of the blower 108 (that is decreased by the decrement module 114) is below the baseline speed (540), then the baseline module 118 increases or increments the operating speed of the blower 108 (549). Thus, similar to the increment module 116, the baseline module 118 prevents the blower 108 from operating at an operating speed that can lead to problems and/or failures within the light source 100.

In one example, decrementing and incrementing the operating speed of the blower 108 can include adjusting the operating speed of the blower 108 within a blower speed range defined by a minimum blower speed and a maximum blower speed. In other words, the operating speed of the blower 108 is adjusted by the increment and decrement modules 114, 116 (and also the baseline module 118) between the minimum blower speed and the maximum blower speed. As described above, the blower speed range is a safe range within which the light source 100 does not have problems and/or failures, and properly operates. Thus, the apparatus 110 can control the operating speed of the blower 108 by adjusting the operating speed within the safe blower speed range such that minimal energy is consumed by the blower 108 and the energy consumed by the light source 100 is reduced.

In some implementations, the procedure 760 further includes determining the increment and decrement speed step sizes of the blower 108, each speed step size being dependent on the fault status 327 relating to the one or more operating conditions of the light source 100. Specifically, one or more studies of the light source 100 can be performed by, for example, a user to determine the largest increment and decrement speed step sizes that both maintain stability of the light source 100 and do not adversely affect performance of the light source 100 (and so that the fault status 327 of the light source 100 remains clear). Moreover, the procedure 760 can further include determining the blower speed range of the blower 108, the blower speed range being dependent on the fault status 327 of the one or more operating conditions of the light source 100. Similarly, one or more studies of the light source 100 can be performed by, for example, a user to determine the minimum blower speed and the maximum blower speed (and, therefore, the blower speed range) such that the performance of the light source 100 is not adversely affected when the blower 108 operates within the blower speed range (and so that the fault status 327 of the light source 100 remains clear).

Referring back to FIG. 3, in some implementations, at least one of the operating conditions (that is associated with a respective performance metric 320_1 to 320_N) of the light source 100 is proactive and at least one of the operating conditions is reactive or risk responsive. Specifically, for a proactive operating condition, the operating speed of the blower 108 is adjusted (for example, by the increment module 116 or the decrement module 114) prior to the value 323_1 to 323_N of the associated performance metric 320_1 to 320_N not being within the threshold range 324_1 to 324_N of the performance metric 320_1 to 320_N. For a reactive operating condition, the operating speed of the blower 108 is adjusted (for example, by the increment module 116 or the decrement module 114) after the value 323_1 to 323_N of the associated performance metric 320_1 to 320_N is not within the threshold range 324_1 to 324_N of the performance metric 320_1 to 320_N. Moreover, in some implementations, each proactive operating condition is associated with a limited threshold range that is tighter than the actual threshold range 324_1 to 324_N of the performance metric 320_1 to 320_N, and the operating speed of the blower 108 is adjusted (for example, by the increment module 116 or the decrement module 114) prior to the value 323_1 to 323_N of the associated performance metric 320_1 to 320_N not being within the actual threshold range 324_1 to 324_N by determining the fault status 325_1 to 325_N of the proactive operating condition based on the limited threshold range.

Referring to FIG. 8, an implementation 800 of the light source 100 (FIG. 1) includes a light generation apparatus 805 including two gas discharge chambers 804A, 804B, the light generation apparatus 805 producing a pulsed output light beam 802 directed to a lithography exposure apparatus 801. The pulsed output light beam 802 has a wavelength in the ultraviolet range (for example, in the deep ultraviolet range) for use by the lithography exposure apparatus 801 for patterning a semiconductor substrate or wafer 870. In the example of FIG. 8, the gas discharge chamber 804A is a part of a master oscillator configured to produce a seed light beam 802s and the gas discharge chamber 804B is a part of a power amplifier configured to produce the output light beam 802 from the seed light beam 802s. Each of the discharge chambers 804A, 804B includes a respective blower 808A, 808B, each of the blowers 808A, 808B being configured to displace a respective gas mixture 807A, 807B including a gain medium from a respective energy source 806A, 806B within the respective gas discharge chamber 804A, 804B. In the example of FIG. 8, the apparatus 110 is configured as an apparatus 810 that is configured to control operating speeds of the two blowers 807A, 807B. Specifically, the apparatus 810 controls the blowers 807A, 807B to consume a minimal amount of energy or power during operation of the light source 800, while ensuring that problems and/or failures within the light source 800 do not occur (or, are at least reduced). Other implementations of the light source 800 are possible.

Each discharge chamber 804A, 804B is configured to hold the respective gas mixture 807A, 807B in a respective interior cavity 873A, 873B. The gas mixture 807A, 807B used in the respective discharge chamber 804A, 804B can be a combination of suitable gases for producing the respective light beam 802s, 802 around the required wavelengths, bandwidth, and energy. For example, the gas mixture 807A, 807B can include argon fluoride (ArF), which emits light at a wavelength of about 193 nm. Each discharge chamber 804A, 804B is defined by respective chamber walls 803A_1, 803A_2, 803B_1, 803B_2 configured to hold the respective blowers 808A, 808B and, in this implementation, respective optical components 875A, 876A, 877A, 875B, 876B, 877B. Each discharge chamber 804A, 804B houses the respective energy source 806A, 806B configured to supply energy to the gas mixture 807A, 807B in each interior cavity 873A, 873B. For example, each energy source 806A, 806B can include a pair of electrodes that form a potential difference and, in operation, excite the gain medium of the gas mixture 807A, 807B.

Each discharge chamber 804A, 804B can include one or more optical components. For example, the discharge chamber 804A includes the optical components 875A, 876A associated with the interior cavity 873A of the discharge chamber 804A. The optical components 875A, 876A can include windows that allow a light beam to travel in to and out of the interior cavity 873A of the discharge chamber 804A. The optical component 875A can be a partially reflecting/partially transmitting optical coupler to enable the seed light beam 802s to exit the discharge chamber 804A. Moreover, the light source 800 can further include other optical components external to the discharge chamber 804A such as the optical component 877A corresponding to a spectral feature selection module that selects a wavelength and/or a bandwidth of the seed light beam 802s output from the discharge chamber 804A. For example, the spectral feature selection module 877A can include one or more of beam expansion prisms or beam splitters. In this example, the optical component 875A is held within the chamber wall 803A_1 and the optical component 876A is held within the chamber wall 803A_2.

The discharge chamber 804B includes the optical components 875B, 876B associated with the interior cavity 873B of the discharge chamber 804B. The optical components 875B, 876B can include windows that allow a light beam (such as the seed light beam 802s and light beam 802) to travel in to and out of the interior cavity 873B of the discharge chamber 804B. Moreover, the light source 800 can further include other optical components external to the discharge chamber 804B such as an optical component 877B corresponding to a beam reverser or turner configured to direct the light beam 802 back through the discharge chamber 804B. In the example of FIG. 8, the optical component 875B is held within the chamber wall 803B_1 and the optical component 876B is held within the chamber wall 803B_2.

During operational use of the light source 800, the apparatus 810 controls the respective operating speeds of the two blowers 807A, 807B. In some implementations, the control of the operating speed of the blower 807A can be independent of the control of the operating speed of the blower 807B. In some implementations, each blower 808A, 808B is independently controlled by a dedicated apparatus (810A, 810B). Moreover, the apparatus 810B can be designed differently from the apparatus 810A to account for differences between how the discharge chambers 804A, 804B affect parameters of the output light beams. Additionally, while control of the blowers 808A, 808B is not coupled in these implementations, their simultaneous control by way of the apparatus 810A, 810B could couple in performance differently than when controlling only one because each blower 808A, 808B drives vibrations in the frame of the chamber 804A, 804B in a different manner.

In other implementations, the control of the operating speed of the blower 807A and/or the blower 807B can rely on performance metrics associated with the light generation apparatus 805 and thus the control of the two blowers 807A, 807B can be coupled.

In some implementations, it is possible to have a single apparatus 810 configured to control the blower 810A of the first discharge chamber 804A but not using the apparatus 810 to control the blower 810B of the second discharge chamber 804B.

Specifically, in the example of FIG. 8, the apparatus 810 includes a monitoring module (such as the monitoring module 112 of the apparatus 110 in FIG. 2), the monitoring module configured to monitor the fault status of one or more operating conditions of the light source 800. Additionally, the apparatus 810 includes a decrement module (such as the decrement module 114 of the apparatus 110 in FIG. 2), the decrement module configured to reduce the operating speed of the appropriate blower 808A, 808B if the fault status relating to one or more operating conditions of the light source 800 is clear and if the decreased operating speed of the respective blower 808A, 808B would be at or above a baseline speed. The apparatus 810 also includes an increment module (such as the increment module 116 of the apparatus 110 in FIG. 2), the increment module configured to increase the operating speed of the appropriate blower 808A, 808B if the fault status relating to one or more operating conditions of the light source 800 is flagged. In this way, the apparatus 810 controls the blowers 808A, 808B to consume a minimal amount of energy or power during operation of the light source 800, such that problems and/or failures within the light source 800 are reduced or mitigated based on the fault status of the light source 800 and the baseline speed of the blower 808A, 808B.

Referring to FIG. 9A. an implementation 900 of the light source 100 (FIG. 1) includes a light generation apparatus 905 including a plurality of optical oscillators 909-1 to 909-N that each include a respective gas discharge chamber 904-1 to 904-N, and produces a pulsed light beam 902 directed to a lithography exposure apparatus 901, and a control system 950. The light source 900 is configured to produce an output light beam 902 in the ultraviolet range for use by, for example, the lithography exposure apparatus 901 for patterning a semiconductor substrate or wafer 970. Specifically, the lithography exposure apparatus 901 exposes the wafer 970 with a shaped exposure beam 902′ that is formed by passing the light beam 902 (which is an exposure beam in this example) through a projection optical system 995. In the example of FIG. 9A, the light generation apparatus 905 includes N optical oscillators 909-1 to 909-N, and therefore, N gas discharge chambers 904-1 to 904-N, where N is an integer that is greater than one. Each of the gas discharge chambers 904-1 to 904-N is configured to emit a respective light beam 978-1 to 978-N toward a beam combiner 993. In the example shown, the control system 950 is connected to the light generation apparatus 905 and the lithography exposure apparatus 901. Other implementations of the light source 900 are possible.

Each of the gas discharge chambers 904-1 to 904-N includes a respective blower 908-1 to 908-N, each of the blowers 908-1 to 908-N being configured to displace a respective gas mixture 907-1 to 907-N including a gain medium from a respective energy source 906-1 to 906-N within the respective gas discharge chamber 904-1 to 904-N. In the example of FIG. 9A, an apparatus 910 (which is an implementation of the apparatus 110) is included as a part of the control system 950. The apparatus 910 is configured as a blower controller to control operating speeds of the blowers 908-1 to 908-N. Specifically, the apparatus 910 controls each blower 908-1 to 908-N to consume a minimal amount of energy or power during operation of the light source 900, while ensuring that problems and/or failures within the light source 900 do not occur (or, are at least reduced).

The details of the optical oscillator 909-1 are discussed below. The other N-1 optical oscillators in the light generation apparatus 905 include the same or similar features.

The optical oscillator 909-1 includes the gas discharge chamber 904-1, which houses an energy source 906-1 that can include, for example, a cathode and an anode, and the blower 908-1. The discharge chamber 904-1 also contains a gas mixture 907-1 including a gain medium. A resonator is formed between a spectral feature selection module 977-1 on one side of the discharge chamber 904-1 and an output coupler 980-1 on a second side of the discharge chamber 904-1. The spectral feature selection module 977-1 can include a diffractive optic such as, for example, a grating and/or a prism, that finely tunes the spectral output of the discharge chamber 904-1. In some implementations, the spectral feature selection module 977-1 includes a plurality of diffractive optical elements. For example, the spectral feature selection module 977-1 can include four prisms, some of which are configured to control a center wavelength of the light beam 978-1 and others of which are configured to control a spectral bandwidth of the light beam 978-1.

In some implementations, the spectral feature selection module 977-1 can include or be in communication with a spectral feature control system that is configured to control, for example, various components within the spectral feature selection module 977-1. In these implementations, the apparatus 910 includes a decrement module (similar to the decrement module 114) and an increment module (similar to the increment module 116). Together, the decrement module and the increment module of the apparatus 910 can be configured to avoid interfering blower operating speeds at which the aliased frequency of the second harmonic of the blower 908-1 interferes with the spectral feature control system associated with the light source 900. For example, the interfering blower operating speeds can be dependent on a repetition rate at which the light source 900 produces light beams (including the light beam 902 or the exposure beam 902′ in this example).

The optical oscillator 909-1 also includes a line center analysis module 981-1 that receives an output light beam from the output coupler 980-1. The line center analysis module 981-1 is a measurement system that can be used to measure or monitor the wavelength of the light beam 978-1. The line center analysis module 981-1 can provide data to the control system 950, and the control system 950 can determine metrics related to the light beam 978-1 based on the data from the line center analysis module 981-1. For example, the control system 950 can determine a beam quality metric or a spectral bandwidth based on the data measured by the line center analysis module 981-1.

The light generation apparatus 905 also includes a gas supply system 990 that is fluidly coupled to an interior of the discharge chamber 904-1 via a fluid conduit 998. The fluid conduit 998 is any conduit that is capable of transporting a gas or other fluid with no or minimal loss of the fluid. For example, the fluid conduit 998 can be a pipe that is made of or coated with a material that does not react with the fluid or fluids transported in the conduit 998. The gas supply system 990 includes a chamber 991 that contains and/or is configured to receive a supply of the gas or gasses used in the gas mixture 907-1. The gas supply system 990 also includes devices (such as pumps. valves, and/or fluid switches) that enable the gas supply system 990 to remove gas from or inject gas into the discharge chamber 904-1. The gas supply system 990 is coupled to the control system 950. The gas supply system 990 can be controlled by the control system 950 to perform, for example, a refill procedure.

The other N-1 optical oscillators are similar to the optical oscillator 904-1 and have similar or the same components and subsystems. For example, each of the optical oscillators 909-1 to 909-N includes an energy source similar to the energy source 906-1, a spectral feature selection module similar to the spectral feature selection module 977-1, and an output coupler similar to the output coupler 980-1. The optical oscillators 909-1 to 909-N can be tuned or configured such that all of the light beams 978-1 to 978-N have the same properties or the optical oscillators 909-1 to 909-N can be tuned or configured such that at least some optical oscillators have at least some properties that are different from other optical oscillators. For example, all of the light beams 978-1 to 978-N can have the same center wavelength, or the center wavelength of each light beam 978-1 to 978-N can be different. The center wavelength produced by a particular one of the optical oscillators 909-1 to 909-N can be set using the respective spectral feature selection module.

The light generation apparatus 905 also includes a beam control apparatus 992 and the beam combiner 993. The beam control apparatus 992 is between the gas mixture of the optical oscillators 909-1 to 909-N and the beam combiner 993. The beam control apparatus 992 determines which of the light beams 978-1 to 978-N are incident on the beam combiner 993. The beam combiner 993 forms the exposure beam 902 from the light beam or light beams that are incident on the beam combiner 993. In the example shown, the beam control apparatus 992 is represented as a single element. However, the beam control apparatus 992 can be implemented as a collection of individual beam control apparatuses. For example, the beam control apparatus 992 can include a collection of shutters, with one shutter being associated with each optical oscillator 909-1 to 909-N.

The light generation apparatus 905 can include other components and systems. For example, the light generation apparatus 905 can include a beam preparation system 994 that includes a bandwidth analysis module that measures various properties (such as the bandwidth or the wavelength) of a light beam. The beam preparation system 994 also can include a pulse stretcher (not shown) that stretches each pulse that interacts with the pulse stretcher in time. The beam preparation system 994 also can include other components that are able to act upon light such as, for example, reflective and/or refractive optical elements (such as, for example, lenses and mirrors), and/or filters. In the example shown, the beam preparation system 994 is positioned in the path of the exposure beam 902. However, the beam preparation system 994 can be placed at other locations within the light source 900. Moreover, other implementations are possible. For example, the light generation apparatus 905 can include N instances of the beam preparation system 994, each of which is placed to interact with one of the light beams 978-1 to 978-N. In another example, the light generation apparatus 905 can include optical elements (such as mirrors) that steer the light beams 978-1 to 978-N toward the beam combiner 993.

The lithography exposure apparatus 901 can be a liquid immersion system or a dry system. The lithography exposure apparatus 901 includes a projection optical system 995 through which the exposure beam 902 passes prior to reaching the wafer 970, and a sensor system or metrology system 997. The wafer 970 is held or received on a wafer holder 996. Referring also to FIG. 9B, the projection optical system 995 includes a slit 995a, a mask 995b, and a projection objective, which includes a lens system 995c. The lens system 995c includes one or more optical elements. The exposure beam 902 enters the lithography exposure apparatus 901 and impinges on the slit 995a, and at least some of the beam 902 passes through the slit 995a to form the shaped exposure beam 902′. In the example of FIGS. 9A and 9B, the slit 995a is rectangular and shapes the exposure beam 902 into an elongated rectangular shaped light beam, which is the shaped exposure beam 902′. The mask 995b includes a pattern that determines which portions of the shaped light beam are transmitted by the mask 995b and which are blocked by the mask 995b. Microelectronic features are formed on the wafer 970 by exposing a layer of radiation-sensitive photoresist material on the wafer 970 with the exposure beam 902′. The design of the pattern on the mask is determined by the specific microelectronic circuit features that are desired.

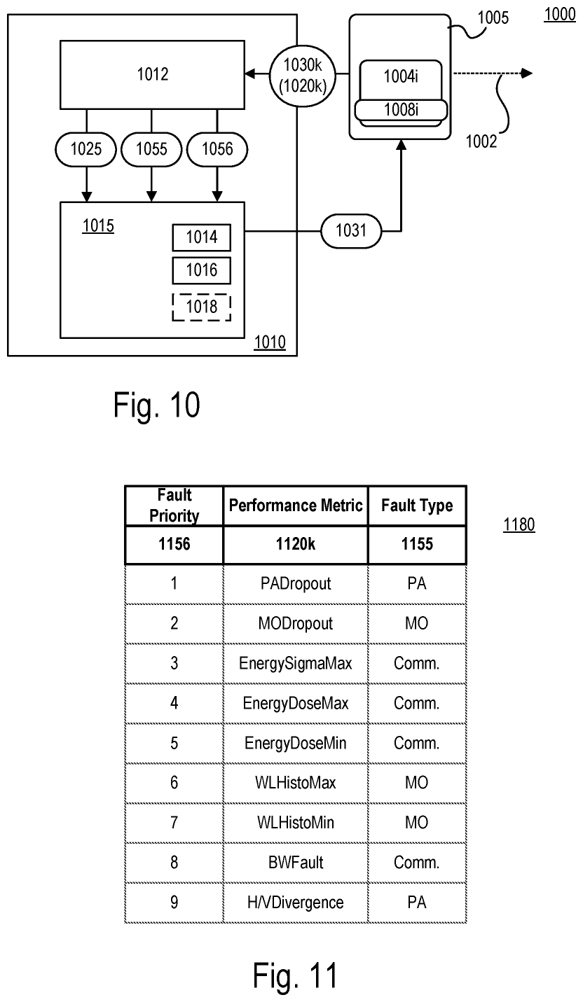

As noted above with reference to FIGS. 8 and 9A, the apparatus 810/910 is configured to work with respective light generation apparatuses 805/905 of respective light sources 800/900. Referring to FIG. 10, an implementation 1010 of the apparatus 810 or 910 is shown with a light generation apparatus 1005 of a light source 1000 that produces a light beam 1002, which is a pulsed light beam. The light source 1000 can correspond to the light source 800 including the light generation apparatus 805 or the light source 900 including the light generation apparatus 905. The light generation apparatus 1005 includes a plurality of gas discharge chambers 1004i, where i is a set of integers from 1 to an integer greater than 1. For example, the gas discharge chambers 1004i can correspond to gas discharge chambers 804A and 804B of the light generation apparatus 805, or the gas discharge chambers 1004i can correspond to the gas discharge chambers 904-1 to 904-N of the light generation apparatus 905. Each gas discharge chamber 1004i includes or holds a blower 1008i.

The apparatus 1010 includes a fault monitoring module 1012 and a control module 1015. The fault monitoring module 1012 is similar, in some general aspects, to the monitoring module 112 and the control module 1015 is similar, in some general aspects, to the control module 115. Furthermore, the fault monitoring module 1012 and the control module 1015 have some additional features that further improve how the apparatus 1010 controls, adjusts, or changes the operating speeds of the blowers 1008i.

The fault monitoring module 1012 is configured to, at regular intervals of usage of the light source 1005, monitor one or more operating conditions 1030k of the light source 1000, where k is either 1 (if one operating condition is monitored) or is a set of integers from 1 to an integer greater than 1. The fault monitoring module 1012 is configured to, for each monitored operating condition 1030k, determine a fault status 1025 and a fault type 1055 that relates to which blower 1008i of one of the gas discharge chambers 1004i within the light source 1000 influences the monitored operating condition 1030k. The fault monitoring module 1012 can also be configured to, for each monitored operating condition 1030k, determine a fault priority 1056 associated with or related to the monitored operating condition 1030k. The fault priority 1056 indicates a level of importance or urgency associated with clearing a flagged fault status 1025 of a particular monitored operating condition 1030k. Some monitored operating conditions 1030k have a higher priority when it comes to clearing any flagged faults than other monitored operating conditions 1030k. The control module 1015 receives the determined fault statuses 1025 and the determined fault types 1055 from the fault monitoring module 1012. The control module 1015 is configured to select at least one of the gas discharge chambers 1004i. The control module 1015 is configured to send an instruction 1031 to the blower 1008i in the selected gas discharge chamber 1004i. The instruction 1031 is based on the determined fault statuses 1025 and the determined fault types 1055.

As discussed above, each of the one or more operating conditions 1030k of the light source 1000 is defined by a performance metric 1020k (where k again is a set of integers from 1 to a number greater than 1), the performance metric 1020k relating to the light source 1005 or to the light beam 1002 produced by the light source 1005. Performance metrics 1020k can be influenced by the speed of one or more blowers 1008i associated with respective gas discharge chambers 1004i. For example, and with reference to FIG. 8, a performance metric 1020k that relates to wavelength performance of the light beam 1002 is more likely to be influenced by the speed of the blower 808A in the gas discharge chamber 804A. As another example, a performance metric 1020k that relates to bandwidth performance of the light beam 1002 is more likely to be influenced by the speed of the blower 808A in the gas discharge chamber 804A. On the other hand, beam parameters (which are parameters of the light beam 1002) are more likely to be influenced by the speed of the blower 808B in the gas discharge chamber 804B. As a further example, parameters associated with energy performance in the light beam 1002 are likely to be influenced by the speed of both blowers 808A, 808B in both gas discharge chambers 804A, 804B. Similar to the apparatus 110, the apparatus 1010 adjusts or changes the operating speed of one or more of the blowers 1008i based on the fault status or statuses 1025 of these one or more operating conditions 1030k. Moreover, the apparatus 1010 also adjusts or changes the operating speed of one or more of the blowers 1008i based on the fact that faults of particular operating conditions 1030k are influenced by specific gas discharge chambers 1004i. The apparatus 1010 is able to select which blower 1008i to adjust or to maintain by considering the fault type 1055 of each fault.

Referring to a table 1180 shown in FIG. 11, in the example of the light source 800 of FIG. 8, in which there are two gas discharge chambers 804A, 804B, there are three fault types 1155 associated with each fault status 1025 of each operating condition 1030i defined by the performance metrics 1120k. Additionally, as discussed below, each fault status 1025 can have an associated fault priority 1156 that indicates the level of importance in clearance any associated flagged fault status 1025. In this example, the three fault types 1155 can be: master oscillator (or MO) for the first gas discharge chamber 804A, power amplifier (PA) for the second gas discharge chamber 804B, and common (Comm.) for a fault that is influenced by both gas discharge chambers 804A, 804B. Examples of performance metrics 1120k that can be monitored by the apparatus 1010 are also shown in the table 1180. The performance metrics 1120k listed are: PADropout, MODropout, EnergySigmaMax, Energy DoseMax, EnergyDoseMin, WLHistoMax, WLHistoMin, BWFault, H/VDivergence. For example, as discussed above, the dropout performance metric 1120k (PADropout or MODropout) corresponds to the dropout rate, which quantifies the failure mechanism in which the blower of that gas discharge chamber is unable to sufficiently clear the portion of the recovering gas mixture and thus the gas mixture is not moved fast enough through that gas discharge chamber, which causes arcing and energy loss in the gas discharge chamber. The EnergySigmaMax performance metric 1120k corresponds to a maximum standard deviation of an energy in the light beam 1002. The Energy DoseMax/Min performance metric 1120k corresponds to a maximum/minimum moving average of an error in the energy of the light beam 1002. The WLHistoMax/Min performance metric 1120k corresponds to the average value of the wavelength +30 (respectively) of the light beam 1002. The BWFault performance metric 1120k corresponds to the bandwidth of the light beam 1002 being out of range. The H/VDivergence performance metric 1120k is a measure of a divergence of the light beam 1002.

As can be seen in the exemplary table 1180 of FIG. 11, a fault status 1025 that is flagged associated with the PADropout performance metric 1120k has a fault type 1155 PA. Thus, assuming there is only one fault status 1025 in the current interval of usage, the apparatus 1010 selects the PA (the gas discharge chamber 804B) and any instruction regarding the speed would be sent to the blower 808B of the gas discharge chamber 804B. On the other hand, the apparatus 1010 would not change the speed of the blower 808A of the gas discharge chamber 804A (the MO chamber) because the fault type 1155 associated with the PADropout performance metric 1120k is not an MO fault type. For comparison, a fault status 1025 that is flagged as associated with the MODropout performance metric 1120k has a fault type 1155 MO. Thus, assuming there is only one fault status 1025 in the current interval of usage, the apparatus 1010 selects the MO (the gas discharge chamber 804A) and any instruction 1031 regarding the speed would be sent by the control module 1015 to the blower 808A of the gas discharge chamber 804A (while the speed of the blower 808B is unchanged). As a further example, a fault status 1025 that is flagged associated with EnergyDoseMax metric 1120k has a fault type 1155 Comm (for Common). This means that the fault associated with EnergyDoseMax is influenced by both gas discharge chambers 804A and 804B.

In this way, the apparatus 1010 is able to manage the blower speeds of a plurality of gas discharge chambers by considering not only the fault status 1025 but also the fault type 1155.

Additionally, and with reference again to FIG. 10, the apparatus 1010 can also consider the fault priority 1056 related to the monitored operating condition 1030k. The fault priority 1056 can be considered and analyzed whenever the fault status 1025 is flagged for a plurality of operating conditions 1030k in a current usage interval. In this example, the fault monitoring module 1012 is configured to, for each monitored operating condition 1030k determine the fault priority 1056 relating to the monitored operating condition 1030k. The control module 1015 receives the fault priority 1056 and furthermore selects the gas discharge chamber 1004i based additionally on the fault priority 1056. In this way, the apparatus 1010 determines an instruction and selects at least one of the gas discharge chambers 1004k based on the fault status 1025, the fault type 1055, and the fault priority 1056 during the current interval of usage. If, during a current interval of usage, two or more operating conditions have a flagged fault status 1025, then the apparatus 1010 can compare the fault priorities 1056 for each of these fault statuses 1025 (that are flagged) and select the gas discharge chamber 1004i (and send an instruction 1031 to the blower 1008i of that selected gas discharge chamber 1004i) associated with the performance metric 1120k that has the higher fault priority 1056.

For example, with reference to the exemplary table 1180 of FIG. 11, the fault priority 1156 is assigned to each of the performance metrics 1120k (each associated with an operating condition 1030k). The fault priority 1156 of the PADropout performance metric 1120k is 1, which means that the PADropout performance metric 1120k has the highest priority and the fault priority 1156 of the MODropout performance metric 1120k is 2, which means that the MODropout performance metric 1120k has the second highest priority but is lower than that of the PADropout performance metric 1120k. Thus, if the fault statuses 1025 of the PADropout performance metric 1120k and the MODropout performance metric 1120k are both flagged during a current usage interval, then the control module 1015 can select the gas discharge chamber 804B (the PA gas discharge chamber) and send the instruction 1031 to the blower 808B of the gas discharge chamber 804B because the PADropout performance metric 1120k (and operating condition) has a higher priority (to clear any faults) and the fault type 1155 for the PADropout performance metric 1120i is the PA fault type (associated with the PA gas discharge chamber).

As another example and with reference to the exemplary table 1180 of FIG. 11, the Dropouts (both PA and MO) have higher fault priorities 1156 (1 and 2, respectively) than the H/VDivergence performance metric 1120i (which has a fault priority 1156 of 9).

As discussed above, the fault status 1025 determined by the fault monitoring module 1012 for the operating condition 1030k is either flagged if the performance metric 1020k associated with the monitored operating condition 1030k is not within a threshold range of that performance metric 1020k or clear if the performance metric 1020k associated with the monitored operating condition 1030k is within the threshold range of that performance metric 1020k. The control module 1015 selects a gas discharge chamber 1004i only if the fault status 1025 is flagged.

As discussed above, the control module 1015 is similar, at least in some general aspects, to the control module 115. Accordingly, the control module 1015 can include an increment module 1014, a decrement module 1016, and optionally a baseline module 1018. The modules 1014, 1016, and 1018 can be configured with additional components or systems that are detailed above and discussed with respect to modules 114, 116, and 118. As discussed above, the increment module 1014 is configured to increase the operating speed of a particular blower 1008i and the decrement module 1016 is configured to decrease the operating speed of a particular blower 1008i. The baseline module 1018 is configured to adjust a baseline speed of a particular blower 1008i, as detailed above.

As discussed above, for each monitored operating condition 1030k, the fault monitoring module 1012 determines the fault status 1025, fault type 1055, and fault priority 1056. This fault information is then received by the control module 1015, which accordingly selects at least one gas discharge chamber 1004i and sends the instruction 1031 to the corresponding blower 1008i. According to the instruction 1031, the increment and decrement modules 1014 and 1016 can be configured to adjust the operating speed of the selected blower 1008i. Also according to the instruction 1031, the baseline module 1018 can be configured to adjust the baseline speed of the selected blower 1008i. For example, if the operating speed of the selected blower 1008i is determined to be below the baseline speed, the baseline module 1018 can be used to increase or increment the operating speed of the blower 1008i.

The baseline module 1018 can also be configured to adjust the baseline speed of one or more blowers 1008i based on other parameters, including the age or operation time of the gas discharge chamber 1004i of a given blower 1008i. For example, the baseline speed of a blower 1008i of a gas discharge chamber 1004i that has been in operation longer can be increased more by the baseline module 1018, than that of a blower 1008i with a gas discharge chamber 1004i that has been in operation less time.

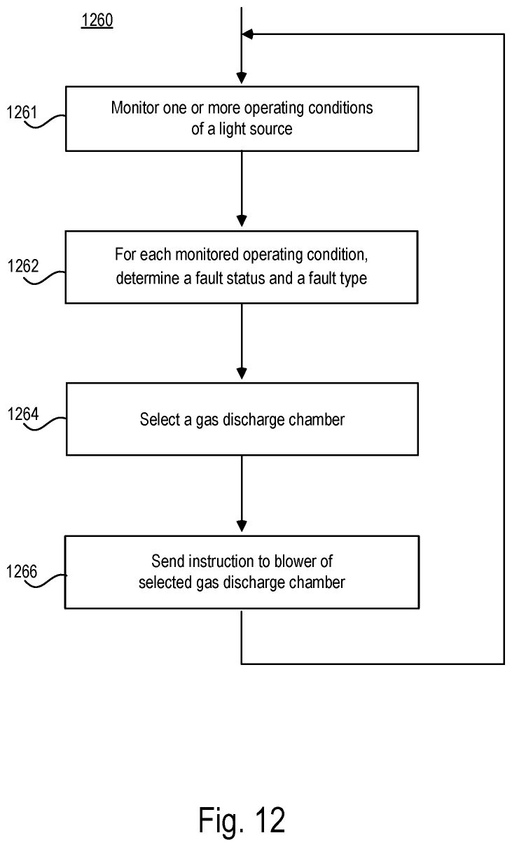

Referring to FIG. 12, the apparatus 1010 (which is an implementation of the apparatus 110, 810, or 910) performs a procedure 1260 for controlling a plurality of blowers (such as the blowers 1008i), with each blower being arranged in a gas discharge chamber (such as the gas discharge chambers 1004i) of the light source 1000.

The procedure 1260 includes monitoring one or more operating conditions 1030k of the light source 1000 (1261). For example, as discussed above with reference to FIG. 10, the fault monitoring module 1012 monitors, at regular intervals of usage of the light source 1000 (and the light generation apparatus 1005), one or more operating conditions 1030k of the light source 1000. As discussed above, k is either 1 if there is a single operating condition 1030k being monitored, or k is a set of integers from 1 to an integer number greater than 1 if there are a plurality of operating conditions 1030i being monitored. For each monitored operating condition 1030k (1261), the apparatus 1010 (for example, the fault monitoring module 1012) determines the fault status 1025 and the fault type 1055 (1262). As discussed above, the fault type 1055 relates to which blower 1008i of a gas discharge chamber 1004i influences the monitored operating condition 1030k. In particular, the fault type 1055 can relate to the blower 1008i of the gas discharge chamber 1004i that has the greatest influence on the monitored operating condition 1030k. In some implementations, the apparatus 1010 (specifically, the fault monitoring module 1012) can also determine the fault priority 1056 at 1262.

Next, the apparatus 1010 (for example, the control module 1015, once it receives the fault status 1025 and the fault type 1055 from the fault monitoring module 1012) selects at least one gas discharge chamber 1004i (1264). As discussed above, the control module 1015 can select the at least one gas discharge chamber 1004i (1264) based on the determined fault status 1025 and the determined fault type 1055. For example, and with reference to FIGS. 8 and 11, the PA gas discharge chamber 804B can be selected at 1264 if the only operating condition that has a fault status 1025 that is flagged corresponds to the PADropout performance metric 1120k because the fault type for this performance metric 1120k is PA 1155 (FIG. 11).

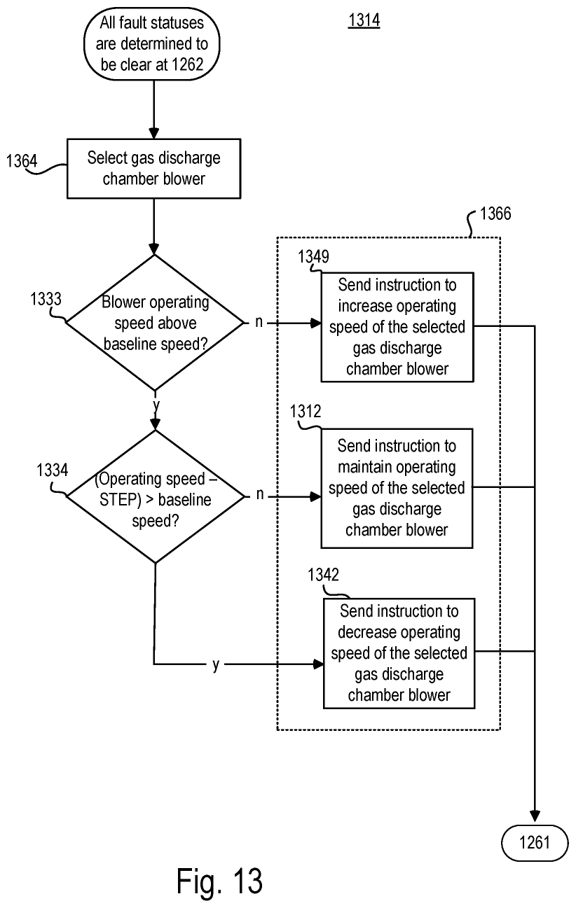

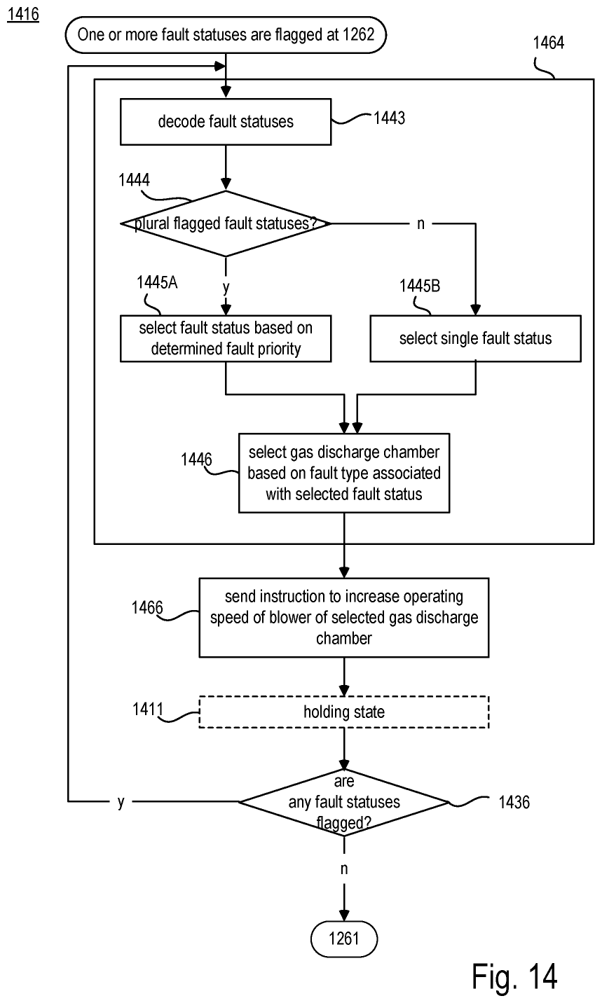

The apparatus 1010 (by way of the control module 1015) sends the instruction 1031 to the blower 1008i of the selected at least one gas discharge chamber 1004i (1266), the instruction 1031 being based on the determined fault statuses 1025 and the determined fault types 1055. This instruction 1031 can lead to an adjustment or change in the operating speed (or the baseline speed) of the blower 1008i. The instruction 1031 to adjust or change the operating speed of the blower 1008i according to the determined fault status 1025 and fault type 1055, are further discussed in detail below in reference to FIGS. 13 and 14. After the instruction 1031 is sent at 1266, then the procedure 1260 advances to the next interval of usage and returns to step 1261. In some implementations, the interval of usage is a constant value. In other implementations, the interval of usage is generally a constant value but can be adjusted or reset to a different value depending on the action or actions taken at step 1266.

Referring to FIG. 13, a proactive mode or state is entered if the control module 1015 determines that none of the fault statuses 1025 (determined at step 1262) are flagged. In the proactive state, a procedure 1314 is performed by the control module 1015. The proactive state can include aspects of the decrement state 514 of FIG. 6A and the baseline state 518 of FIG. 6C. On the other hand, and referring to FIG. 14, a risk mode or state is entered if the control module 1015 determines that one or more of the fault statuses 1025 (determined at step 1262) are flagged. In the risk state, a procedure 1416 is performed by the control module 1015. The risk state can include aspects of the increment state 516 of FIG. 6D. The proactive state procedure 1314 of FIG. 13 is discussed next, followed by the risk state procedure 1416 of FIG. 14.

Referring to FIG. 13, in the proactive state procedure 1314, at least one discharge chamber 1004i blower 1008i is selected at 1264 (FIG. 12). The selected blower 1008i operating speeds are determined and instructions 1031 are sent by the control module 1015 accordingly to complete step 1266 as shown in FIG. 12. For example, the gas discharge chamber blower 1008i can be selected at 1364 based on the gas discharge chamber blower 1008i that was selected during the most recent prior interval of usage. Thus, with reference to FIG. 8, if, during the most recent prior interval of usage, the blower 808A in the gas discharge chamber 804A was selected at 1364 for further analysis, then the blower 808B in the gas discharge chamber 804B can be selected at 1364 in the current interval of usage. In this way, in this example, the analysis alternates between the blowers 808A and 808B for each interval of usage.

The control module 1015 (for example, by way of the decrement module 1014) determines whether the operating speed of the selected blower 1008i is greater than the baseline speed (1333). If the operating speed of the selected blower 1008i is not greater than the baseline speed (1333) (which means it is either at or less than or crosses below the baseline speed of the selected blower 1008i), then the control module 1015 sends the instruction 1031 (FIG. 10) to increase the operating speed of the selected blower 1008i (1349). The new setpoint for the blower speed can be calculated by adding, for example, the increment speed step size to the current blower speed. For example, the increment speed step size can be 5 rpm. Moreover, the control module 1015 can also reset the interval of usage at this time if it is appropriate. For example, the interval of usage can be set to 10,000,000 pulses of the light beam 1002.

If the operating speed of the selected blower 1008i is greater than the baseline speed (1333), then the control module 1015 determines whether a proposed new blower speed would be greater than the baseline speed (1334). The proposed new blower speed corresponds to the current operating speed of the selected blower 1008i minus a decrement speed step size. If the proposed new speed of the selected blower 1008i would not be greater than the baseline speed (that is, the proposed new blower speed would be either at the baseline speed or less than the baseline speed at 1334), then the control module 1015 sends the instruction 1031 to maintain the operating speed of the selected blower 1008i (1312). Basically, this corresponds to the state machine 510 transitioning from the decrement state 514 to the monitoring state 512 in FIG. 5.

If the proposed new blower speed would be greater than the baseline speed (1334), then the control module 1015 sends the instruction 1031 to decrease or decrement the operating speed of the selected blower 1008i (1342). The control module 1015 can calculate the new operating speed of the selected blower 1008i by subtracting the decrement speed step size (STEP) from the current operating speed of the selected blower 1008i. The decrement speed step size can be, for example, 5 rpm.

The operating speed of the selected blower 1008i is reduced (1342) by a decrement speed step size. On the other hand, the operating speed of the selected blower 1008i is increased (1349) by an increment speed step size. The increment speed step size can be larger than the decrement speed step size. For example, an increment speed step size can be 5 rotations per minute (rpm) while a decrement speed step size can be 5 rpm. In some implementations, the increment speed step size can be any value less than or equal to 25 rpm and the decrement speed step size can be less than this value. Thus, if the increment speed step size is 20 rpm, the decrement speed step size can be 5 or 10 rpm.

In addition, the control module 1015 can also control the baseline speed of each blower 1008i of each gas discharge chamber 1004i in the light generation apparatus 1005. The control of the baseline speed of a particular blower 1008i can be based on an age of the gas discharge chamber 1004i in which it is housed. This is discussed above with reference to FIGS. 4A-4C.

Referring to FIG. 14, in the risk state procedure 1416, the control module 1015 has already determined that at least one fault status 1025 has been flagged at 1262. Next, the control module 1015 performs a procedure 1464 to select a gas discharge chamber 1004i. Initially, the control module 1015 decodes the fault statuses (1443). Specifically, the control module 1015 analyzes the fault status of each monitored operating condition to determine which one or more fault statuses are flagged (1443). The control module 1015 determines if more than one fault status 1025 has been flagged (1444). If the control module 1015 determines that only a single fault status 1025 has been flagged (1444), then it selects that single fault status (1445B). If the control module 1015 determines that there are a plurality of flagged fault statuses 1025 (1444), then it selects one fault status 1025 for further action based on the determined fault priority 1056 (1445A). For example, as discussed above, and with reference to the table 1180 of FIG. 11, the control module 1015 can select a single fault status 1025 for further action at 1445A by selecting the fault status 1025 associated with the performance metric 1120k having the highest priority 1156. In the table 1180, the lower numbers in the priority 1156 column correspond to higher priorities 1156. Thus, the PADropout performance metric 1120k has the highest priority 1156 and the H/VDivergence performance metric 1120k has the lowest priority 1156 in the table 1180. Next, the control module 1015 selects a gas discharge chamber 1004i based on the fault type associated with the selected fault status 1025 (1446). Once the gas discharge chamber 1004i is selected at 1446, the control module 1015 sends the instruction 1031 to increase the operating speed of the blower 1008i in the selected gas discharge chamber 1004i (1466).

As discussed above, and with reference to FIG. 11, some faults (associated with some performance metrics 1120k) are influenced by more than one gas discharge chamber 1004i. In this case, the control module 1015 can select the gas discharge chamber 1004i based on the fault type 1055 Common associated with a selected fault status 1025 at step 1446 by taking into account other factors. For example, the control module 1015 can select the gas discharge chamber 1004i in the current interval of usage that is distinct from the gas discharge chamber 1004i selected at step 1446 in the most recent prior interval of usage. Thus, if, during the most recent prior interval of usage, the speed of the blower 808B of the gas discharge chamber 804B was increased (for example, by 25 rpm) at step 1466 (FIG. 14), and during the current interval of usage, the Common fault type 1055 is associated with a flagged fault status 1025 (FIG. 14), then the speed of the blower 808A of the gas discharge chamber 804A can be increased (for example, by 25 rpm) at step 1466 (FIG. 14) in the current interval of usage. As another example, in other implementations, if, during the most recent prior interval of usage, the speed of the blower 808B of the gas discharge chamber 804B was reduced (for example, by 5 rpm) at step 1342 (FIG. 13), and during the current interval of usage, the Common fault type 1055 is associated with a flagged fault status 1025, then the speed of the blower 808A of the gas discharge chamber 804A can be increased (for example, by 25 rpm) at step 1466 (FIG. 14). On the other hand, in still other implementations, the control module 1015 can select the gas discharge chamber 1004i in the current interval of usage (if a Common fault type 1044 is associated with a flagged fault status 1025 (FIG. 14) that is the same as the gas discharge chamber 1004i selected at step 1342 (FIG. 13). If, during the most recent prior interval of usage, the speed of the blower 808B of the gas discharge chamber was reduced (for example, by 5 rpm) at step 1342 (FIG. 13), and during the current interval of usage, the Common fault type 1055 is associated with a flagged fault status 1025, then the speed of the blower 808B of the gas discharge chamber 804B can be increased (for example, by 25 rpm) at step 1466 (FIG. 14).

In some implementations, the control module 1015 enters a holding state after sending the instruction 1031 to the blower 1008i of the selected gas discharge chamber 1004i (1411). The holding state can correspond to a holding interval of usage, such as, for example, 10,000,000 pulses of the light beam 1002. During the holding state (1411), no actions are taken by the control module 1015. The purpose of the holding state (1411) is to avoid taking an action during the next interval of usage that is in response to a transient condition (which can show up as a flagged fault at step 1262 in the next interval of usage). The control module 1015 further determines if any fault statuses 1025 are still flagged (1436). If any one of the fault statuses 1025 is still flagged at 1436, then the control module 1015 repeats the risk state procedure 1416. If all of the fault statuses 1025 are clear (and none are flagged) at 1436, then the control module 1015 can thereby exit the risk state procedure 1416 and return to monitoring one or more operating conditions 1030k of the light source 1000 (1261). The control module 1015 can also reset the interval of usage length prior to exiting the risk state procedure 1416. For example, the interval of usage can be reset to 100,000,000 pulses of the light beam 1002.

In summary, during the risk state procedure 1416, because a fault status 1025 is flagged, none of the blowers 1008i should be decremented until the control module 1015 determines that all faults are clear at 1436; only the blower 1008i in the gas discharge chamber 1004i associated with the fault type 1055 needs to be incremented at 1466, and if there are a plurality of flagged fault statuses 1025 that occur at the same time, the control module 1015 addresses the fault type 1055 that is most harmful to performance of the light source 1000 by selecting the one having the highest priority 1056 at 1445A.

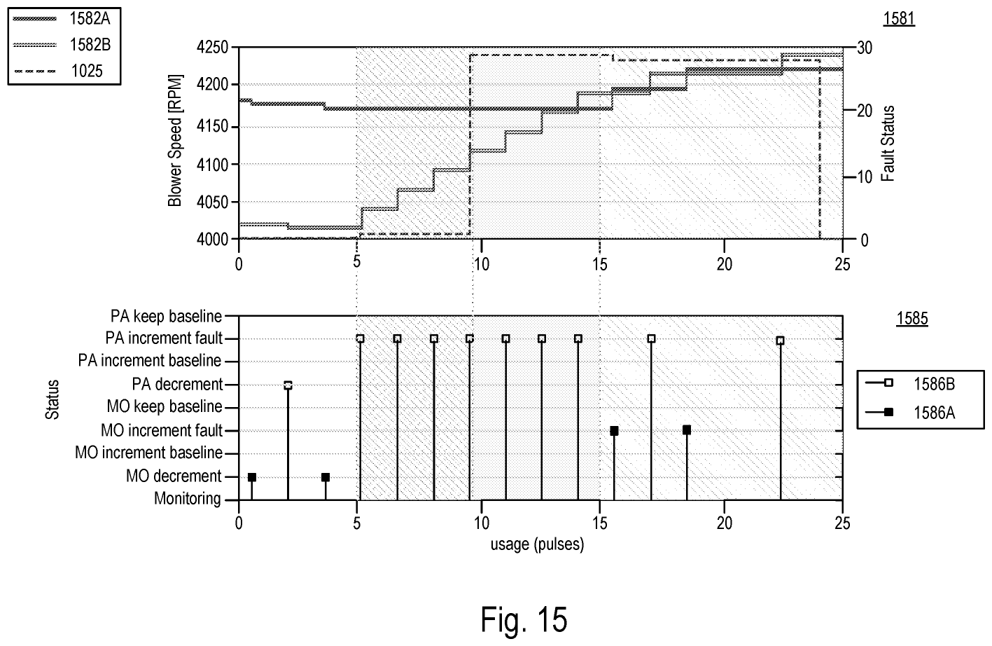

Referring to FIG. 15, a graph 1581 is shown aligned with a graph 1585. The graphs 1581 and 1585 correspond to a simulation that shows how the apparatus 1010 responds depending on the health of the light source 1000 (as determined from the monitored operating conditions 1030k). In this simulation, it is assumed that a PA fault type 1055 has a higher fault priority 1056 than a Common fault type 1055. Reference is made to the apparatus 1010 of FIG. 10 and the light source 800 of FIG. 8 when discussing the graphs 1581 and 1585.

In graph 1581, a speed setpoint of a blower 1008i is tracked versus usage of the light source 800. The speed setpoint of the blower 808A of the gas discharge chamber 804A is shown by the solid line (which is denoted by 1582A) and the speed setpoint of the blower 808B of the gas discharge chamber 804B is shown by the double line (which is denoted by 1582B). A fault status 1025 is shown by the dashed line. The usage can be denoted by the number of pulses of the light beam 1002 produced by the light source 1000, and in this example, it is given in millions of pulses of the light beam 1002. Thus, the value 5 on the horizontal axis of graph 1581 corresponds 0 to 5,000,000 million pulses of the light beam 1002.

In graph 1585, a status of the apparatus 1010 is depicted along the vertical axis. Moreover, each status that is depicted is categorized as either an event 1586A relating to the blower 808A of the gas discharge chamber 804A or an event 1586B relating to the blower 808B of the gas discharge chamber 804B.

From 0 to 5 units of usage, the fault status 1025 is zero (0), which means that no faults are flagged. From 5 to 9 units of usage, the fault status 1025 is two (2), which means that two faults are flagged. Moreover, the fault type 1055 of both of these flagged faults is the PA fault type 1155. From 9 to 15 units of usage, the fault status 1025 is 28, which means that 28 faults are flagged. Moreover, the fault type 1055 of these flagged faults includes a mixture of the PA fault type 1155 and the Common fault type 1155. From 16 to 24 units of usage, the fault status 1025 is 26, and the fault type 1055 of these flagged faults is solely the Common fault type 1155.

At the beginning of the simulation, from 0 to 5 units of usage, there are no flagged faults since the fault status 1025 is zero (0). During this time, the apparatus 1010 operates in the proactive state in which the apparatus 1010 performs the procedure 1260 and the procedure 1314. The control module 1015 alternates between the two gas discharge chambers each time the procedure 1260 is performed. Initially, the gas discharge chamber 804A is selected at step 1264, and the operating speed of the blower 808A is decremented at step 1342 (as indicated by the decrease in the line 1582A of graph 1581 and the “MO decrement” status of graph 1585). After this, the gas discharge chamber 804B is selected at step 1264 (after an interval of usage has passed), and the operating speed of the blower 808B is decremented at step 1342 (as indicated by the decrease in the line 1582B of graph 1581 and the “PA decrement” status of graph 1585). Then, the gas discharge chamber 804A is selected again at step 1264 (after an interval of usage has passed), and the operating speed of the blower 808A is decremented at step 1342 (as indicated by the decrease in the line 1582A of graph 1581 and the “MO decrement” status of graph 1585).

From 5 to 15 units of usage, there are flagged faults. The value of the fault status 1025 is about 28 in the graph 1581 and, as discussed above, the control module 1015 decodes the value and determines which one or more fault statuses are flagged (at 1443). The control module 1015 determines that the fault statuses that are flagged include those that have PA fault type 1155 (from 5-9 units of usage) and also those that have Common fault type 1155 (from 9-15 units of usage). Thus, the apparatus 1010 operates in the risk state in which the apparatus 1010 performs the procedure 1260 and the procedure 1416. As mentioned above, in this simulation, it is assumed that a PA fault type 1155 has a higher fault priority 1056 than a Common fault type 1155. Thus, at all times during this usage frame (5-15 units of usage), the control module 1015 selects the gas discharge chamber 804B at step 1446 and sends an instruction 1031 to increase the operating speed of the blower 808B at each interval of usage. This is shown by the steps in the double line 1582B of graph 1581 and also shown by the “PA increment fault” status of graph 1585.

From 16 to 24 units of usage, the fault status 1025 is 26 (as indicated in the graph 1581), and the fault type 1055 of these flagged faults is solely the Common fault type 1155. Thus, the apparatus 1010 operates in the risk state in which the apparatus 1010 performs the procedure 1260 and the procedure 1416. Because the only fault type is the Common fault type 1155, the control module 1010 alternates and selects the gas discharge chamber 804A at step 1446 and sends an instruction 1031 to increase the operating speed of the blower 808A at the next interval of usage. This is shown by the steps in the single line 1582A of graph 1581 and also shown by the “MO increment fault” status of graph 1585. In general, the control module 1010 alternates increasing the operating speed of the blower 808A and the operating speed of the blower 808B with each interval of usage. After the operating speed of the blower 808A is increased at usage unit 18, the control module 1010 resets the interval of usage to a larger value moving forward. Thus, the next action is taken at usage unit 22, where the control module 1010 sends an instruction 1031 to increase the operating speed of the blower 808B, as shown by the step in the double line 1582B of graph 1581 and also shown by the “PA increment fault” status of graph 1585.

The implementations can be further described using the following clauses:
1. A control apparatus for a light source including a plurality of gas discharge chambers with a blower being arranged in each gas discharge chamber, the control apparatus comprising:
a fault monitoring module configured to monitor one or more operating conditions of the light source, and, for each monitored operating condition, determine a fault status and a fault type that relates to which blower of a gas discharge chamber influences the monitored operating condition; and
a control module configured to receive the determined fault statuses and the determined fault types from the fault monitoring module; select at least one gas discharge chamber; and send an instruction to the blower in the selected at least one gas discharge chamber, the instruction being based on the determined fault statuses and the determined fault types.
2. The control apparatus of clause 1, wherein:
the fault monitoring module is configured to, for each monitored operating condition, determine a priority relating to the monitored operating condition; and
the control module is configured to select the at least one gas discharge chamber based on the determined priority.
3. The control apparatus of clause 1, the fault monitoring module is configured to monitor the one or more operating conditions of the light source at regular intervals of usage of the light source, and the control module is configured to select at least one gas discharge chamber based on the gas discharge chamber that was selected by the control module during the most recent prior interval of usage.
4. The control apparatus of clause 1, wherein the plurality of gas discharge chambers includes a master oscillator gas discharge chamber and a power amplifier gas discharge chamber optically in series with the master oscillator gas discharge chamber, and the fault type is selected from a set of possible fault types that includes a power amplifier fault type, a master oscillator fault type, and a common fault type.
5. The control apparatus of clause 1, wherein each of the one or more operating conditions is defined by a performance metric relating to the light source or to a light beam produced by the light source.
6. The control apparatus of clause 5, wherein the one or more performance metrics include:
a wavelength histogram associated with the light beam;
an energy dose error associated with the light beam;
an energy error associated with the light beam;
a bandwidth error associated with the light beam;
an operating point of a master oscillator gas discharge chamber;
an operating point of a power amplifier gas discharge chamber;
a spectral feature accuracy associated with the light beam; and
an actuator operating point of the light source.
7. The control apparatus of clause 1, wherein the fault status determined for the monitored operating condition is:
flagged if a performance metric associated with the monitored operating condition is not within a threshold range of that performance metric; or
clear if the performance metric associated with the monitored operating condition is within the threshold range of that performance metric.
8. The control apparatus of clause 1, wherein the fault monitoring module is configured to determine an overall fault status based on the determined fault statuses of each monitored operating condition, and the control module being configured to select at least one gas discharge chamber and to send the instruction to the blower in the selected at least one gas discharge chamber comprises the control module decoding the overall fault status to analyze the determined fault status of each monitored operating condition.
9. The control apparatus of clause 1, wherein the control module being configured to select at least one gas discharge chamber and to send the instruction to the blower in the selected at least one gas discharge chamber comprises the control module being configured to operate in proactive mode if all of the determined fault statuses are clear and to operate in risk mode if any one of the determined fault statuses are flagged.
10. The control apparatus of clause 9, wherein, in proactive mode, the control module is configured to send an instruction to reduce an operating speed of the blower in the selected at least one gas discharge chamber by a decrement speed step size and, in risk mode, the control module is configured to send an instruction to increase an operating speed of the blower in the selected at least one gas discharge chamber by an increment speed step size that is larger than the decrement speed step size.
11. The control apparatus of clause 10, wherein the increment speed step size is less than or equal to 40 rotations per minute (rpm), and the decrement speed step size is about one half, one third, one fourth, or one fifth of the increment speed step size.
12. The control apparatus of clause 9, wherein, in proactive mode, the control module is configured to:
select one of the gas discharge chambers; and
send an instruction to reduce an operating speed of the blower arranged in the selected gas discharge chamber to a decreased operating speed if the decreased operating speed is above a baseline speed.
13. The control apparatus of clause 12, wherein the control module is further configured to send an instruction to increase the operating speed of the blower arranged in the selected gas discharge chamber if a current operating speed of the blower arranged in the selected gas discharge chamber is below the baseline speed and to send an instruction to maintain the operating speed of the blower arranged in the selected gas discharge chamber if the current operating speed of the blower arranged in the selected gas discharge chamber is at the baseline speed.
14. The control apparatus of clause 12, further comprising a baseline module configured to control the baseline speed of each blower of each gas discharge chamber, the control of a particular blower baseline speed being related to an age of the gas discharge chamber in which the blower is housed.
15. The control apparatus of clause 9, wherein:
the fault monitoring module is further configured to determine a fault priority for each monitored operating condition; and
in risk mode, the control module is configured to:
analyze the fault status of each monitored operating condition to determine which one or more fault statuses are flagged;
if a plurality of fault statuses are flagged, then select one of the flagged fault statuses based on the determined fault priority, and, if a single fault status is flagged, then select that single flagged fault status;
select a gas discharge chamber based on the fault type associated with the selected fault status: and send an instruction to increase the operating speed of the blower of the selected gas discharge chamber.
16. The control apparatus of clause 15, wherein:
the fault type is associated with a single gas discharge chamber or is associated with a plurality of gas discharge chambers; and
in risk mode, the control module being configured to select the gas discharge chamber based on the fault type associated with the selected fault status comprises either selecting the single gas discharge chamber associated with the fault type or selecting a gas discharge chamber from the plurality of gas discharge chambers associated with the fault type.
17. The control apparatus of clause 15, wherein, in risk mode, after the operating speed of the blower of the selected gas discharge chamber has been increased, the control module is configured to: enter a holding state;
after the holding state ends:
receive, for each monitored operating condition, the next determined fault status and fault type from the fault monitoring module;
analyze the fault status of each monitored operating condition to determine which one or more fault statuses are flagged;
if any of the one or more fault statuses are flagged, then:
if a plurality of fault statuses are flagged, then select one of the flagged fault statuses based on the determined fault priority, and, if a single fault status is flagged, then select that single flagged fault status;
select a gas discharge chamber based on the fault type associated with the selected fault status; and send an instruction to increase the operating speed of the blower of the selected gas discharge chamber; and
if none of the one or more fault statuses are flagged, then exit risk mode and wait for the next determined fault status and fault type from the fault monitoring module.
18. The control apparatus of clause 1, wherein the fault monitoring module is configured to monitor the one or more operating conditions of the light source at regular intervals of usage of the light source, and the regular intervals of usage of the light source is measured as a number of pulses of a light beam produced by the light source.
19. The control apparatus of clause 18, wherein the regular intervals of usage include first regular intervals of usage and second regular intervals of usage that are greater than the first regular intervals of usage, the fault monitoring module being configured to operate using the second regular intervals of usage after both determining a flagged fault status using the first regular interval of usage and subsequently determining zero flagged fault statuses in a next interval of usage.
20. A method for controlling a plurality of blowers, each blower arranged in a gas discharge chamber of a light source, the method comprising:
at regular intervals of usage of the light source, monitoring one or more operating conditions of the light source;
for each monitored operating condition, determining a fault status and a fault type that relates to which blower of a gas discharge chamber influences the monitored operating condition; selecting at least one gas discharge chamber; and
sending an instruction to the blower in the selected at least one gas discharge chamber, the instruction being based on the determined fault statuses and the determined fault types.
21. The method of clause 20, further comprising, for each monitored operating condition, determining a priority relating to the monitored operating condition: and
wherein selecting the at least one gas discharge chamber comprises selecting the at least one gas discharge chamber based on the determined priority.
22. The method of clause 20, wherein selecting the at least one gas discharge chamber comprises selecting the at least one gas discharge chamber based on the gas discharge chamber that was selected during the most recent prior interval of usage.
23. The method of clause 20, wherein the fault status determined for the monitored operating condition is:
flagged if a performance metric associated with the monitored operating condition is not within a threshold range of the performance metric; or
clear if the performance metric associated with the monitored operating condition is within the threshold range of the performance metric.
24. The method of clause 20, further comprising determining an overall fault status based on the determined fault statuses of each monitored operating condition,
wherein selecting at least one gas discharge chamber and sending the instruction to the blower in the selected at least one gas discharge chamber comprises decoding the overall fault status to analyze the determined fault status of each monitored operating condition.
25. The method of clause 20, wherein selecting at least one gas discharge chamber and sending the instruction to the blower in the selected at least one gas discharge chamber comprises operating in proactive mode if all of the determined fault statuses are clear and operating in risk mode if any one of the determined fault statuses are flagged.
26. The method of clause 25, wherein, in the proactive mode, sending the instruction to the blower comprises sending an instruction to reduce an operating speed of the blower in the selected at least one gas discharge chamber by a decrement speed step size and, in the risk mode, sending the instruction to the blower comprises sending an instruction to increase an operating speed of the blower in the selected at least one gas discharge chamber by an increment speed step size that is larger than the decrement speed step size.
27. The method of clause 25, wherein, in the proactive mode:
selecting at least one gas discharge chamber comprises selecting one of the gas discharge chambers; and
sending the instruction to the blower comprises sending an instruction to reduce an operating speed of the blower arranged in the selected gas discharge chamber to a decreased operating speed if the decreased operating speed is above a baseline speed.
28. The method of clause 27, wherein sending the instruction to the blower further comprises sending an instruction to increase the operating speed of the blower arranged in the selected gas discharge chamber if a current operating speed of the blower arranged in the selected gas discharge chamber is at or below the baseline speed and sending the instruction to the blower further comprises sending an instruction to maintain the operating speed of the blower arranged in the selected gas discharge chamber if the current operating speed of the blower arranged in the selected gas discharge chamber is within a threshold value of the baseline speed.
29. The method of clause 27, further comprising controlling the baseline speed of each blower of each gas discharge chamber, the control of a particular blower baseline speed being related to an age of the gas discharge chamber in which the blower is housed.
30. The method of clause 25, further comprising determining a fault priority for each monitored operating condition;
wherein operating in the risk mode comprises:
analyzing the fault status of each monitored operating condition to determine which one or more fault statuses are flagged;
if a plurality of fault statuses are flagged, then selecting one of the flagged fault statuses based on the determined fault priority, and, if a single fault status is flagged, then selecting that single flagged fault status;
selecting a gas discharge chamber based on the fault type associated with the selected fault status; and sending an instruction to increase the operating speed of the blower of the selected gas discharge chamber.
31. The method of clause 30, wherein:
the fault type is associated with a single gas discharge chamber or is associated with a plurality of gas discharge chambers; and
operating in the risk mode comprises selecting the gas discharge chamber based on the fault type associated with the selected fault status including either selecting the single gas discharge chamber associated with the fault type or selecting a gas discharge chamber from the plurality of gas discharge chambers associated with the fault type.
32. The method of clause 30, wherein, operating in the risk mode comprises, after the operating speed of the blower of the selected gas discharge chamber has been increased:
entering a holding state;
after the holding state ends:
analyzing the next determined fault status of each monitored operating condition to determine which one or more fault statuses are flagged;
if any of the one or more fault statuses are flagged, then:
if a plurality of fault statuses are flagged, then selecting one of the flagged fault statuses based on the determined fault priority, and, if a single fault status is flagged, then selecting that single flagged fault status;
selecting a gas discharge chamber based on the fault type associated with the selected fault status; and sending an instruction to increase the operating speed of the blower of the selected gas discharge chamber; and
if none of the one or more fault statuses are flagged, then exiting risk mode and waiting for the next determined fault status and fault type.
33. A control apparatus for a light source including a first gas discharge chamber and a second gas discharge chamber optically in series with the first gas discharge chamber, the control apparatus comprising:
a fault monitoring module configured to, at regular intervals, monitor one or more operating conditions of the light source, and for each monitored operating condition, determine a fault status; and
a control module configured to send a first instruction to a first blower within the first gas discharge chamber and to send a second instruction to a second blower within the second gas discharge chamber, the first instruction and the second instruction relating to a speed of the first blower and second blower, respectively, and the first instruction and the second instruction being based on the determined fault status.

The above described implementations and other implementations are within the scope of the following claims.

1. A control apparatus for a light source including a plurality of gas discharge chambers with a blower being arranged in each gas discharge chamber, the control apparatus comprising:
a fault monitoring module configured to monitor one or more operating conditions of the light source, and, for each monitored operating condition, determine a fault status and a fault type that relates to which blower of a gas discharge chamber influences the monitored operating condition; and
a control module configured to receive the determined fault statuses and the determined fault types from the fault monitoring module; select at least one gas discharge chamber; and send an instruction to the blower in the selected at least one gas discharge chamber, the instruction being based on the determined fault statuses and the determined fault types.

2. The control apparatus of claim 1, wherein:
the fault monitoring module is configured to, for each monitored operating condition, determine a priority relating to the monitored operating condition; and
the control module is configured to select the at least one gas discharge chamber based on the determined priority.

3. The control apparatus of claim 1, the fault monitoring module is configured to monitor the one or more operating conditions of the light source at regular intervals of usage of the light source, and the control module is configured to select at least one gas discharge chamber based on the gas discharge chamber that was selected by the control module during the most recent prior interval of usage.

4. The control apparatus of claim 1, wherein the plurality of gas discharge chambers includes a master oscillator gas discharge chamber and a power amplifier gas discharge chamber optically in series with the master oscillator gas discharge chamber, and the fault type is selected from a set of possible fault types that includes a power amplifier fault type, a master oscillator fault type, and a common fault type.

5. The control apparatus of claim 1, wherein each of the one or more operating conditions is defined by a performance metric relating to the light source or to a light beam produced by the light source.

6. The control apparatus of claim 5, wherein the one or more performance metrics include:
a wavelength histogram associated with the light beam;
an energy dose error associated with the light beam;
an energy error associated with the light beam;
a bandwidth error associated with the light beam;
an operating point of a master oscillator gas discharge chamber;
an operating point of a power amplifier gas discharge chamber;
a spectral feature accuracy associated with the light beam; and
an actuator operating point of the light source.

7. The control apparatus of claim 1, wherein the fault status determined for the monitored operating condition is:
flagged if a performance metric associated with the monitored operating condition is not within a threshold range of that performance metric; or
clear if the performance metric associated with the monitored operating condition is within the threshold range of that performance metric.

8. The control apparatus of claim 1, wherein the fault monitoring module is configured to determine an overall fault status based on the determined fault statuses of each monitored operating condition, and the control module being configured to select at least one gas discharge chamber and to send the instruction to the blower in the selected at least one gas discharge chamber comprises the control module decoding the overall fault status to analyze the determined fault status of each monitored operating condition.

9. The control apparatus of claim 1, wherein the control module being configured to select at least one gas discharge chamber and to send the instruction to the blower in the selected at least one gas discharge chamber comprises the control module being configured to operate in proactive mode if all of the determined fault statuses are clear and to operate in risk mode if any one of the determined fault statuses are flagged.

10. The control apparatus of claim 9, wherein, in proactive mode, the control module is configured to send an instruction to reduce an operating speed of the blower in the selected at least one gas discharge chamber by a decrement speed step size and, in risk mode, the control module is configured to send an instruction to increase an operating speed of the blower in the selected at least one gas discharge chamber by an increment speed step size that is larger than the decrement speed step size.

11. (canceled)

12. (canceled)

13. (canceled)

14. (canceled)

15. The control apparatus of claim 9, wherein:
the fault monitoring module is further configured to determine a fault priority for each monitored operating condition; and
in risk mode, the control module is configured to:
analyze the fault status of each monitored operating condition to determine which one or more fault statuses are flagged;
if a plurality of fault statuses are flagged, then select one of the flagged fault statuses based on the determined fault priority, and, if a single fault status is flagged, then select that single flagged fault status;
select a gas discharge chamber based on the fault type associated with the selected fault status; and
send an instruction to increase the operating speed of the blower of the selected gas discharge chamber.

16. The control apparatus of claim 15, wherein:
the fault type is associated with a single gas discharge chamber or is associated with a plurality of gas discharge chambers; and
in risk mode, the control module being configured to select the gas discharge chamber based on the fault type associated with the selected fault status comprises either selecting the single gas discharge chamber associated with the fault type or selecting a gas discharge chamber from the plurality of gas discharge chambers associated with the fault type.

17. (canceled)

18. (canceled)

19. (canceled)

20. A method for controlling a plurality of blowers, each blower arranged in a gas discharge chamber of a light source, the method comprising:
at regular intervals of usage of the light source, monitoring one or more operating conditions of the light source;
for each monitored operating condition, determining a fault status and a fault type that relates to which blower of a gas discharge chamber influences the monitored operating condition;
selecting at least one gas discharge chamber; and
sending an instruction to the blower in the selected at least one gas discharge chamber, the instruction being based on the determined fault statuses and the determined fault types.

21. (canceled)

22. (canceled)

23. (canceled)

24. (canceled)

25. The method of claim 20, wherein selecting at least one gas discharge chamber and sending the instruction to the blower in the selected at least one gas discharge chamber comprises operating in proactive mode if all of the determined fault statuses are clear and operating in risk mode if any one of the determined fault statuses are flagged.

26. The method of claim 25, wherein, in the proactive mode, sending the instruction to the blower comprises sending an instruction to reduce an operating speed of the blower in the selected at least one gas discharge chamber by a decrement speed step size and, in the risk mode, sending the instruction to the blower comprises sending an instruction to increase an operating speed of the blower in the selected at least one gas discharge chamber by an increment speed step size that is larger than the decrement speed step size.

27. The method of claim 25, wherein, in the proactive mode:
selecting at least one gas discharge chamber comprises selecting one of the gas discharge chambers; and
sending the instruction to the blower comprises sending an instruction to reduce an operating speed of the blower arranged in the selected gas discharge chamber to a decreased operating speed if the decreased operating speed is above a baseline speed.

28. The method of claim 27, wherein sending the instruction to the blower further comprises sending an instruction to increase the operating speed of the blower arranged in the selected gas discharge chamber if a current operating speed of the blower arranged in the selected gas discharge chamber is at or below the baseline speed and sending the instruction to the blower further comprises sending an instruction to maintain the operating speed of the blower arranged in the selected gas discharge chamber if the current operating speed of the blower arranged in the selected gas discharge chamber is within a threshold value of the baseline speed.

29. The method of claim 27, further comprising controlling the baseline speed of each blower of each gas discharge chamber, the control of a particular blower baseline speed being related to an age of the gas discharge chamber in which the blower is housed.

30. (canceled)

31. (canceled)

32. The method of claim 25, wherein, operating in the risk mode comprises:
sending the instruction to increase an operating speed of the blower of the selected at least one gas discharge chamber:
entering a holding state;
after the holding state ends:
analyzing the next determined fault status of each monitored operating condition to determine which one or more fault statuses are flagged;
if any of the one or more fault statuses are flagged, then:
if a plurality of fault statuses are flagged, then selecting one of the flagged fault statuses based on the determined fault priority, and, if a single fault status is flagged, then selecting that single flagged fault status;
selecting a gas discharge chamber based on the fault type associated with the selected fault status; and
sending an instruction to increase the operating speed of the blower of the selected gas discharge chamber; and
if none of the one or more fault statuses are flagged, then exiting risk mode and waiting for the next determined fault status and fault type.

33. A control apparatus for a light source including a first gas discharge chamber and a second gas discharge chamber optically in series with the first gas discharge chamber, the control apparatus comprising:
a fault monitoring module configured to, at regular intervals, monitor one or more operating conditions of the light source, and for each monitored operating condition, determine a fault status; and
a control module configured to send a first instruction to a first blower within the first gas discharge chamber and to send a second instruction to a second blower within the second gas discharge chamber, the first instruction and the second instruction relating to a speed of the first blower and second blower, respectively, and the first instruction and the second instruction being based on the determined fault status.
